(19) United States
(12) Patent Application Publication
(10) Pub. No.: US 2019/0342101 A1
(43) Pub. Date: Nov. 7, 2019

(54) Secure time communication system

(71) Applicants: John William Hayes, Reno, NV (US); Charles Andrew Gram, Reno, NV (US); Whitfield Diffie, Woodside, CA (US)

(72) Inventors: John William Hayes, Reno, NV (US); Charles Andrew Gram, Reno, NV (US); Whitfield Diffie, Woodside, CA (US)

(21) Appl. No.: 15/932,843

(22) Filed: May 4, 2018

(51) Int. Cl. H04L 9/32; H04L 29/06; H04L 9/12

(52) U.S. Cl. CPC H04L 9/3242; H04L 63/0428; H04L 63/1483; H04L 63/1458; H04L 9/12

(57) ABSTRACT

Methods and apparatus for a Secure Time Communication System (10) are disclosed. One embodiment of the invention provides secure and non-interactive communication of clock information over an unsecured communications channel. This communication provides perfect forward secrecy, while detecting and blocking message spoofing, message replay, denial of service and cryptographic performance attacks. This mechanism also bounds the effect of message delay manipulation. The mechanism consists of two components, a filtered time encryptor (16) and a filtered time decryptor (28). The filtered time encryptor (16) produces a message in two parts; a time token followed by an encrypted message body. The time token is used as a filter to detect most attacks and to determine the message key.

### FIELD OF THE INVENTION

One embodiment of the present invention pertains to a secure, non-interactive method for communicating secured time. More particularly, one embodiment of the invention comprises a filtered time encryptor and a filtered time decryptor, which work in combination to provide secure and non-interactive communication of clock information over an unsecured communications channel. This communication provides perfect forward secrecy, while detecting and blocking message spoofing, message replay, denial of service and cryptographic performance attacks.

### CROSS-REFERENCE TO RELATED PENDING PATENT APPLICATIONS, CLAIM FOR PRIORITY & INCORPORATION BY REFERENCE

The Present application is related to a Pending Parent application U.S. Ser. No. 15/530,714, filed on 17 Feb. 2017. The Applicants hereby claim the benefit of priority for all subject matter which is commonly disclosed in the Present application and in U.S. Ser. No. 15/530,714.

The Applicants hereby incorporate by reference all the subject matter presented in U.S. Pat. No. 8,572,695 (U.S. Ser. No. 13/373,586), issued on 29 Oct. 2013; and in U.S. patent application Ser. No. 14/998,645, filed on 26 Jan. 2016.

### FEDERALLY SPONSORED RESEARCH OR DEVELOPMENT

None.

### BACKGROUND OF THE INVENTION

According to a paper by the Cyber Physical Systems Public Working Group entitled DRAFT Timing Framework for Cyber-Physical Systems, Technical Annex, Release 0.8 (September 2015), “every [computer] network element has a clock subsystem (often just called a ‘clock’).” This clock typically contains an oscillator that generates signals that are used to provide a sense of time that is used in that network element or system.

FIG. 1A shows a typical, generic clock waveform.

Time is represented as a continuing series of pulses having a fixed duration, and a fixed separation along the x-axis. The pulses have a constant frequency, meaning that there is a pre-defined and unvarying rate at which events, measured by this framework of time, may occur.

“Time” is a measurement of an interval between two events, or the duration of an event. The progression of time, as measured or determined by an electronic system, controls the implementation of instructions, activities or events.

If a network is penetrated by an unauthorized user, and the time clock within the network is somehow disturbed or altered, the entire network may be compromised or rendered inoperative.

As an example, an article by Pierluigi Paganini entitled Hacking NTP Servers from Long-Distance with Low Cost Devices (May 29, 2016) explains that an attacker may shift time on a network server by sending the server a forged radio time signal. Computer servers generally use the Network Time Protocol to administer their internal clock. A time signal from a satellite or a terrestrial radio station supplies a signal which is recognized as the correct time. If a hacker can send the network an incorrect time signal, the operation of the network may be impaired.

A Basic Analogy that Explains the Problem Confronted by the Prior Art

FIG. 1B is a schematic diagram of a railroad, including a locomotive that runs on tracks between Station A and Station B. The two Stations are 60 miles apart, and, in this example, the locomotive has a constant speed of sixty miles per hour. During a normal run of the locomotive, the trip between the two Stations takes exactly one hour. In FIG. 1B, the clock reads 1500 hours, which is the departure time from Station A.

FIG. 1C is a second schematic diagram that shows the same railroad exactly one hour later, at 1600 hours. For this example, the “correct” time is determined solely by the times that the locomotive departs from Station A, and arrives at Station B. No other sources for the correct time are available.

FIGS. 1D and 1E reveal two additional schematic diagrams that show how a malicious actor could “distort” the correct value of time, as defined by this railroad and its locomotive. In FIG. 1D, the locomotive is diverted from the straight, main track between Stations A & B, and is routed around mountains that are located near the straight line of track. The diversion causes the locomotive to travel from Station A to Station B over a total distance of one hundred and twenty miles. When the locomotive shown in FIG. 1D departs from Station A at 1500 hours, it travels at the same constant speed of sixty miles per hour. Due to the malicious diversion, the locomotive does not arrive at Station B until 1700 hours. If the only source of knowing the correct time is viewing the arrival of the locomotive at Station B, an observer would be tricked into believing that the correct time is 1600 hours, when the correct time is actually 1700 hours.

The analogy between the railroad example and the present invention concerns the determination of the perceived, observed or measured “correct” time at locations on a computer network which is protected and insulated from malicious actors who would seek to introduce time deviations and errors into the system.

The development of a system that would defend networks against “time hacking” would be a major technological advance, and would satisfy long-felt needs in the computer security industry by improving upon the security methods and apparatus currently employed in the communication of time.

### SUMMARY OF THE INVENTION

One embodiment of the present invention is a Secure Time Communication System that defends computer networks against “time-hacking.” One embodiment of the invention provides secure and non-interactive communication of clock information over an unsecured communications channel. This communication provides perfect forward secrecy, while detecting and blocking message spoofing, message replay, denial of service and cryptographic performance attacks. This mechanism also bounds the effect of message delay manipulation. The mechanism consists of two components, a filtered time encryptor and a filtered time decryptor. The filtered time encryptor produces a message in two parts; a time token followed by an encrypted message body. The token is used in conjunction with a filter to detect most attacks and to determine the message key.

An alternate embodiment of the invention communicates authenticated time that provides perfect forward secrecy, while detecting and blocking message spoofing, message replay, denial of service and cryptographic performance attacks. This mechanism also bounds the effect of message delay manipulation. The mechanism includes two components, a filtered time message authentication code (MAC) generator and a filtered time authenticator. The filtered time MAC generator produces a message in three parts; a time token followed by message authentication code, followed by the original message. The token is used as a filter to detect most attacks and to determine the message key. An alternate embodiment of the filtered time MAC generator produces a message in three parts, the original message, followed by a time token and a message authentication code. The time token and message authentication code can be arranged in any order. In this alternate embodiment, with the original message being communicated first enables the retrofitting of existing time communications by placing the time token authentication information at the end of the communication.

The present invention protects the definition or determination of time measurement within an electronic system or network, and thwarts unauthorized use based on interference or tampering with that internal definition or determination of time.

The various embodiments of the present invention disclose a Secure Time Communications System that enable more secure and reliable communications over a network than would be possible using previous systems.

An appreciation of the other aims and objectives of the present invention, and a more complete and comprehensive understanding of this invention, may be obtained by studying the following descriptions of preferred embodiments, and by referring to the accompanying drawings.

### A BRIEF DESCRIPTION OF THE DRAWINGS

FIG. 1A is a schematic diagram of a series of pulses which may used to regulate the time clock in a computer and/or network.

FIGS. 1B, 1C, 1D & 1E are schematic diagrams which provide a mechanical analogy that describes the problem confronted by the prior art.

FIG. 2 provides a view of one embodiment of the Secure Time Communication System.

FIG. 3 shows how the output of a cryptographic hash is used to create a time token and a time token message key.

FIG. 4 shows a schematic of a time token protected message and a schematic of a token cache entry.

FIG. 5 shows an example of an implementation of one embodiment of the Secure Time Communication System.

FIG. 6 shows a flowchart illustrating how a time token protected message is created.

FIG. 7 shows a flowchart illustrating how a token cache entry is created.

FIG. 8 shows a flowchart illustrating how a time token protected message is filtered and decrypted.

FIG. 9 shows a flowchart illustrating how time token protected messages are filtered and discarded.

FIG. 10 shows three schematics of a time token authenticated message.

FIG. 11 shows a flowchart illustrating how a time token authenticated message is created.

FIG. 12 shows a flowchart illustrating how a time token authenticated message is filtered and authenticated.

FIG. 13 shows a flowchart illustrating how time token authenticated messages are filtered and discarded.

FIG. 14 provides a view of one embodiment of the Authenticated Time Communication System.

FIG. 15 shows an example of an implementation of one embodiment of the Authenticated Time Communication System.

FIG. 16 is a chart showing vulnerabilities of present security methods to different forms of attack.

FIG. 17 is a chart showing vulnerabilities of present security methods and the present invention to different forms of attack.

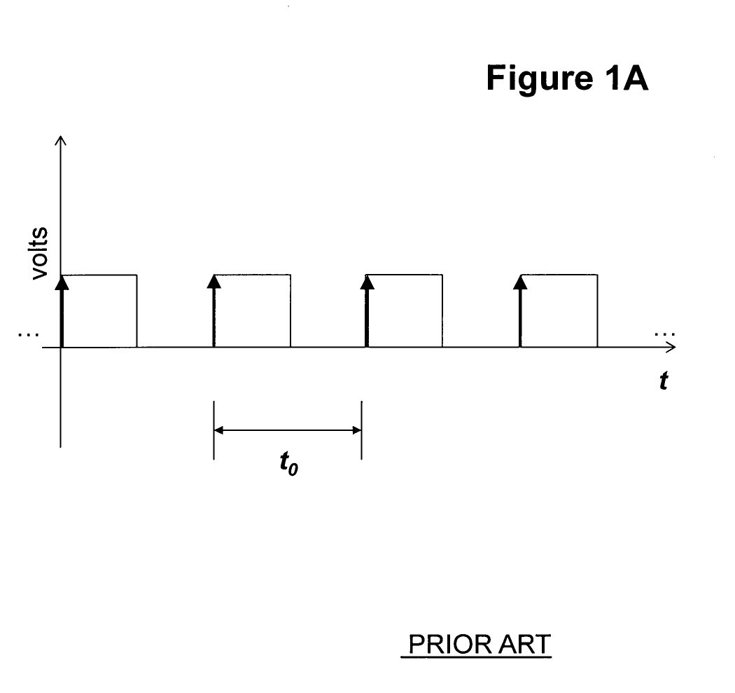

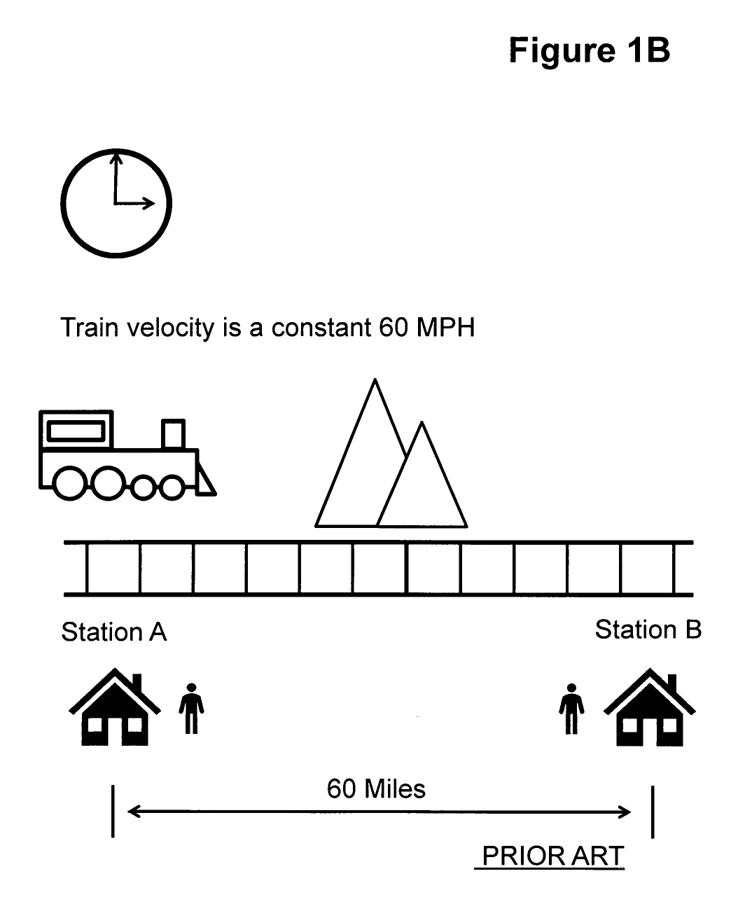

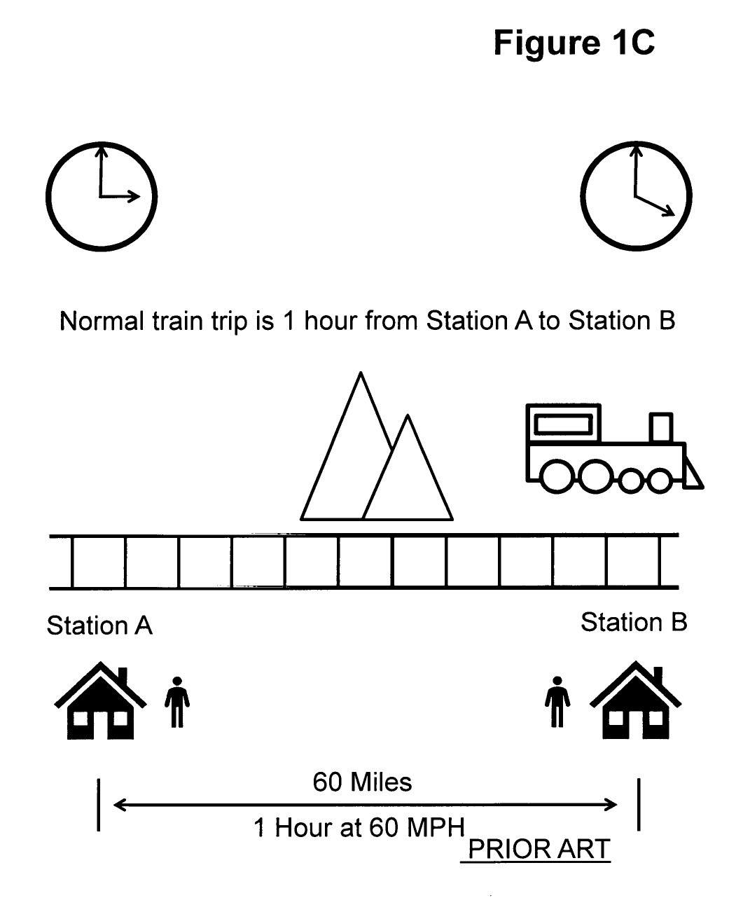

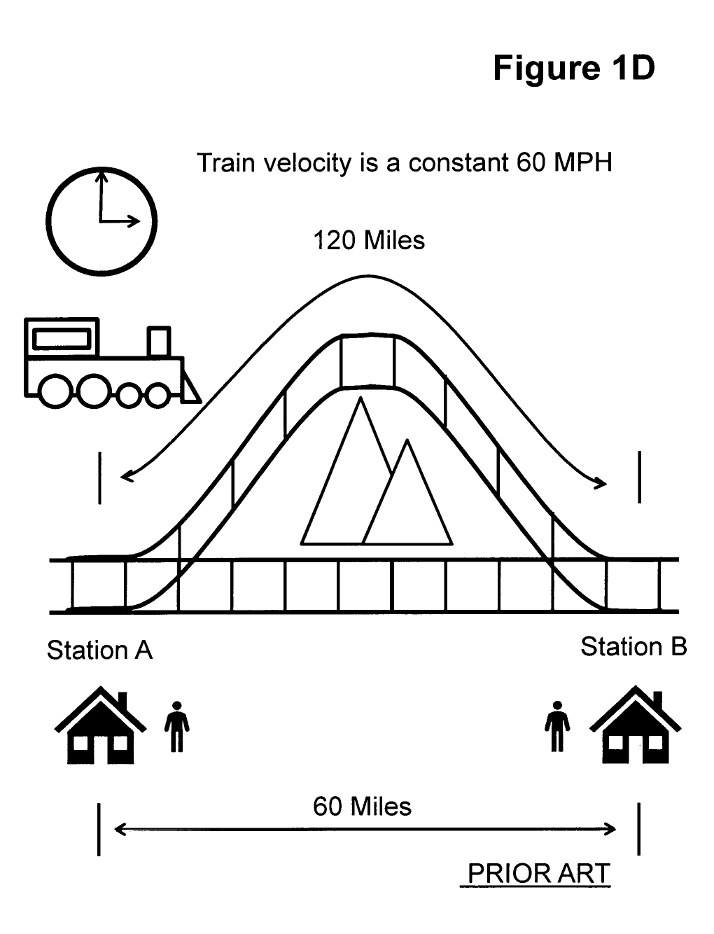

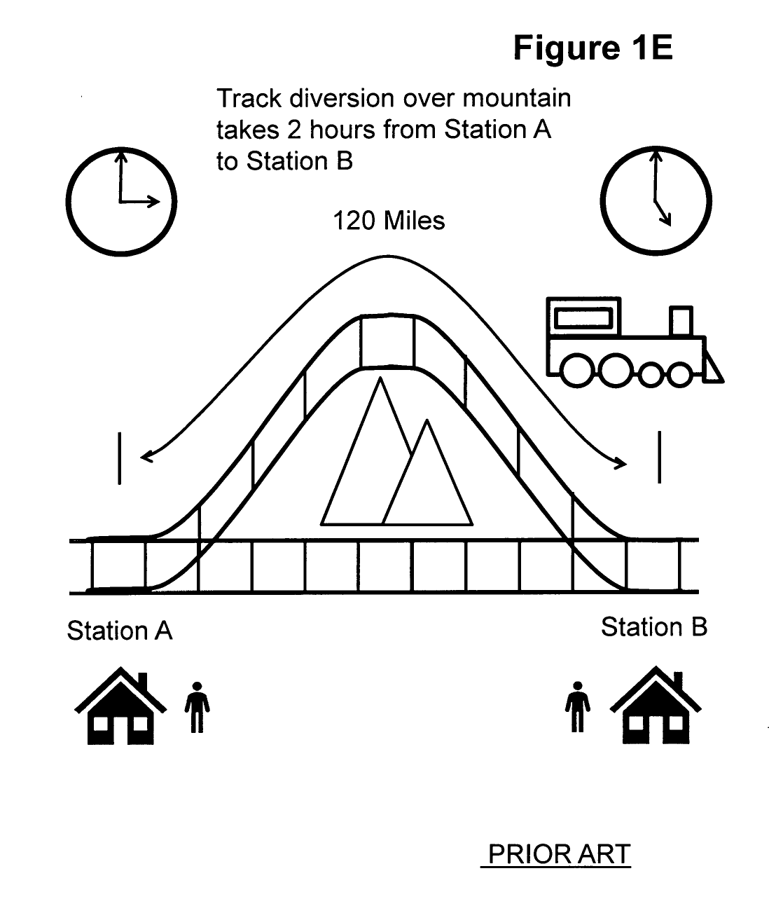

### A DETAILED DESCRIPTION OF PREFERRED & ALTERNATIVE EMBODIMENTS

### I. Overview of the Invention

One embodiment of the present invention pertains to a secure, non-interactive method for communicating secured time. More particularly, one embodiment of the invention comprises a filtered time encryptor and a filtered time decryptor, which work in combination to provide secure and non-interactive communication of clock information over an unsecured communications channel. This communication generally provides perfect forward secrecy, while detecting and blocking message spoofing, message replay, denial of service and cryptographic performance attacks.

An alternate embodiment of the present invention also pertains to a secure, non-interactive method for communicating secured time. More particularly, an alternate embodiment of the invention comprises a filtered time MAC generator and a filtered time authenticator, which work in combination to provide authenticated and non-interactive communication of clock information over an unsecured communications channel. This communication provides perfect forward secrecy, while detecting and blocking message spoofing, message replay, denial of service and cryptographic perfornce attacks.

The present invention preserves and/or defends the recognized value of time within an electronic device or network to prevent unauthorized tampering with or access to the device or network.

The various embodiments of the present invention are directed to specific improvements to the way computers and networks operate.

### II. Description of One Embodiment of the Invention

Tokens, which are strings of data, are generated by using a cryptographic hash of a synchronized clock and a token key that is pre-shared with the filtered time encryptor and the filtered time decryptor(s). A cryptographic hash function is a mathematical expression, which, takes an input, transforms it, and returns a fixed-size output. For example, using a cryptographic hash algorithm with 256 bits of output, 256 bits of token key information and 64 bits of clock information are used as the inputs. The first 64 bits of the resulting hash output are used as the time token. The remaining 192 bits of hash output are used as a message key to encrypt the message body. A message key is a string of bits which is used to encrypt, or to decrypt, a message.

This embodiment of the present invention provides perfect forward secrecy for each message body encrypted with a unique time dependent message key. The message body contains the full resolution clock information and may contain additional message data. The filtered time encryptor and the filtered time decryptor may use a lower resolution clock for token generation. The full resolution clock can be determined after the message body has been decrypted with the message key. Comparing the clock value used for token generation against the clock value included in the message body insures that the message body has been correctly decrypted.

Time tokens are generated by both the filtered time encryptor and the filtered time decryptor. A time token is a time sensitive value that is used to determine the message key. A time token is generated with a specific clock value. The time token is a component of a time token protected message.

Each time token is the partial output of a cryptographic hash. The only way a filtered time decryptor can recognize a valid time token is to match a received token against the set of tokens that is currently valid. Multiple time tokens may be valid simultaneously to account for the effects of clock and propagation delay variances.

Each filtered time decryptor maintains a cache of expected valid tokens. As the time tokens are time dependent, the number of time tokens required to be maintained depends upon the resolution of the clock used for token generation and amount of error allowed between the time token generator and the time token filter. This error includes the frequency and phase drift between the source clock and the local clock in the filtered time decryptor and the variance in the propagation delay. For example, a time token cache maintaining 1000 time tokens with a 100 μs resolution results in an overall time window of 0.1 seconds. Within the time token cache, the time tokens are maintained in a hash table, content addressable memory (CAM) or other suitable mechanisms.

The maintenance of time tokens involves the aging and removal of older time tokens from the cache and the calculation and addition of new time tokens to the cache. In addition to the time token value, each cache, hash table or CAM entry includes the clock value used to generate the time token and the hash output from the time token generation process, providing the message key.

Time token recognition is performed when a message is received by a filtered time decryptor. A lookup in the time token cache is performed for the received time token. If the time token is not found, the entire message is discarded. If the time token is found, its corresponding time token message key is used to decrypt the encrypted time message. The clock information in the hash table entry is used to validate the decrypted time message. If the clock information decrypted from the encrypted time message does not match the clock information used to generate the time token, the message is discarded. A lower resolution clock may be used for time token generation, while the full resolution clock is contained in the decrypted message body.

Because the determination of time token validity is a simple table lookup, it requires the same low computational effort to determine that a time token is valid or is invalid. The bulk of the computational effort occurs in the maintenance of the time token cache which is managed independently from message processing. Once a time token and its associated message key has been used, the time token entry is invalidated and may be removed from the token cache. Time tokens expire and become invalid once they fall outside of the time window established by the time token cache.

### Analysis

The probability of an attacker using a valid time token in a brute force attack is:

$$p ( n ; d ) = \frac{d !}{{d}^{n} ( d - n ) !}$$

where p is the probability; and
n is the number of time tokens in use in the time token cache and d is the number of unique time tokens available.
The variable d is calculated as d=2^{b} where b is the size in bits of the time token. As d! is not directly calculable for large numbers, the approximation

p(n;d)≈1−e⁻ⁿ^{²}^{/(2×d)}

is used. Using the above example with a cache of 1000 time tokens, the probability of an attacker using a valid time token is approximately 2.70894⁻¹⁴.

For comparison, the probability of an attacker using a valid time token when using a cache of 10,000 time tokens is approximately 2.7105⁻¹². The probability of an attacker using a valid time token can be reduced by increasing the time token size.

An attacker must test his attacks against the filtered time decryptor because time tokens are the partial output of a cryptographic hash, and there is no plaintext to compare against. This limits the attack rate to the maximum message rate of the filtered time decryptor. The time tokens in the time token cache are continuously being expired and refreshed, further complicating an attacker's efforts.

### Attack Detection

A message with an invalid time token or an invalid message body is considered an attack. An attack may be caused by a spoofed message or the replay of a previous message which has been invalidated or removed from the time token cache. Denial of service attacks are limited to the maximum message rate of the filtered time decryptor. The time token filter filters out attacks at the maximum message rate while accepting messages with valid time tokens. Cryptographic performance attacks must first pass through the time token filter where they are filtered out before message body decryption is attempted.

### Limiting Message Delay Manipulation

Message delay can be detected and bounded based on the window of time covered by time tokens in the time token cache. Messages delayed outside of this window are invalid. The time token cache management and aging process can invalidate (without removing) time tokens that have aged out of the time window, enabling the detection of message delay manipulation. Messages classified as delayed must have a valid time token and message body, otherwise they are indistinguishable from other forms of attack.

### Initialization

The difference between the source clock and filtered time decryptor's local clock, including propagation delay must be within the time window of the token cache, requiring that the filtered time decryptor's local clock is synchronized to the source clock prior to operation. One embodiment of clock synchronization uses a second clock with a lower resolution and a wider window during initialization, switching to a higher resolution clock once the filtered time decryptor's local clock is within the operational time window. The filtered time encryptor can communicate both clocks independently and the filtered time decryptor can generate both low and high resolution time tokens for its time token cache until high resolution time tokens are recognized. Once synchronized, the filtered time decryptor can cease generating low resolution time tokens.

### Authentication

The approach of using a time token cache can also be used to provide authenticated time communications. Authenticated time is used where the timing information is necessarily communicated unencrypted, but requires assurance that the communicated timing information has not been altered or produced by an imposter clock.

An alternate embodiment providing authenticated time uses a time token, generated as described above and a message authentication code, created using the message key associated with the time token as the cryptographic key.

This embodiment of the present invention provides perfect forward secrecy with each message body authenticated with a unique time dependent message key. The message body contains the original, unencrypted message, a time token and a message authentication code. The message authentication code is generated by using the message key associated with the time token as the key to a hash of the message data. Upon reception, the token is matched against token values present in the token cache. Upon locating a matching token value, a message authentication code is generated using the message key associated with the time token in the token cache. The generated message authentication code is then compared to the received message authentication code. If those values match, the message is authenticated. If those values do not match, the message has not been authenticated and is discarded. Upon successful authentication, the corresponding token cache entry is invalidated to prevent reuse by message replay attacks.

### Applicability

This approach can be used to securely communicate time over broadcast communication systems with multiple filtered time decryptors. The limiting factor is the underlying key management. For example, using a broadcast system such as an FM sideband or GPS, timing information can be securely communicated to multiple filtered time decryptors simultaneously using a single group key. To protect against a compromised filtered time decryptor compromising the entire system, a unique token key should be established for each filtered time decryptor, limiting the effect of a compromised filtered time decryptor. Filtered time decryptors receiving messages generated with a token key different from their own will discard the received messages as invalid.

This approach can also be used in conjunction with interactive time protocols such as NTP and PTP. When used in this way, each participating entity should have their own unique token key and token cache mechanism to generate and authenticate messages. This approach is tolerant of a lossy communications channel, although it cannot detect the absence of lost messages.

The embodiment providing authentication of time communications can be used to retrofit existing time communication systems. In the retrofit application, the original message is communicated as usual. After the original time communication, the time token and the message authentication code are appended. This allows existing, legacy equipment to receive and process time communications. Many communication systems do not check for additional data at the end of a communication. In this way, older, legacy time communications equipment can be made tolerant of new authenticated time communications while newer time communications equipment will be able to fully authenticate a received time communication.

### III. Operation of One Embodiment of the Invention

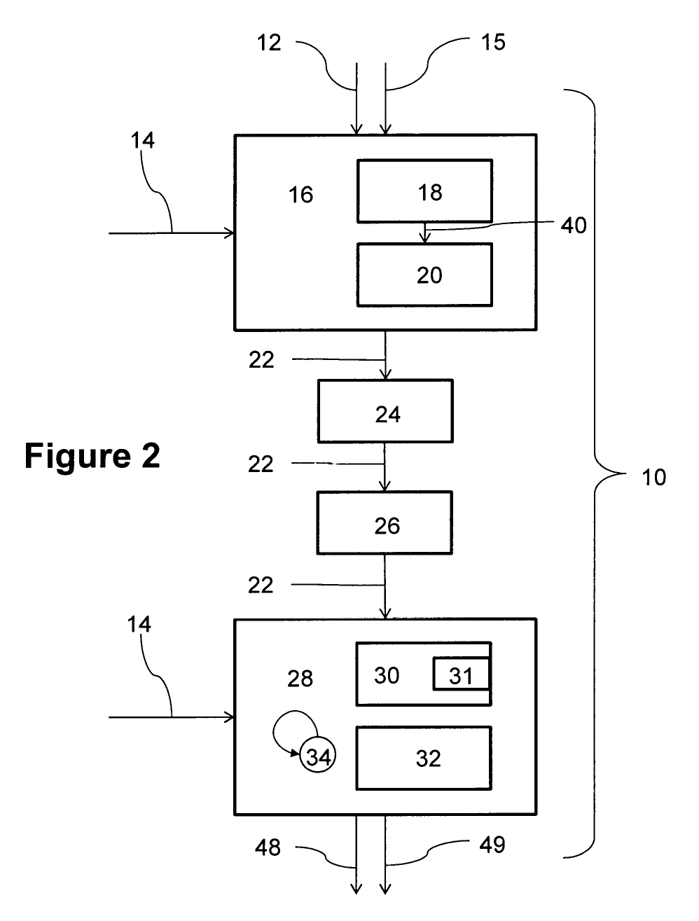

In one implementation of the invention, as shown in FIG. 2, a source clock 12 and a pre-shared key 14 is presented as inputs to a filtered time encryptor 16. An original message 15 may optionally be presented to the filtered time encryptor 16. The filtered time encryptor 16 contains a time token generator 18, providing a means for a time token generator. The filtered time encryptor 16 also contains a message encryptor 20, providing a means for a message encryptor. The filtered time encryptor 16 is connected to a transmitter 24. The transmitter is used to transmit time token protected messages 22 to a receiver 26.

A receiver 26 is connected to a filtered time decryptor 28. The filtered time decryptor 28 contains a time token filter 30 providing a means for a time token filter. The time token filter 30 contains a time token cache 31. The filtered time decryptor 28 also contains a message decryptor 32, providing a means for a message decryptor. The filtered time decryptor 28 also contains a local clock 34.

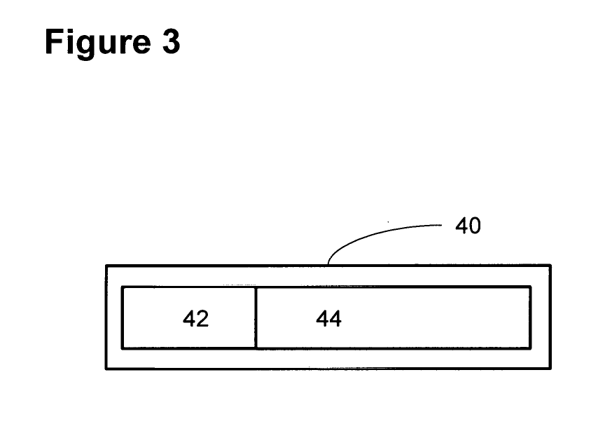

Within the filtered time encryptor 16, the time token generator 18 takes the source clock 12 and the pre-shared key 14 and using a cryptographic hash algorithm, produces a cryptographic hash output 40. The cryptographic hash output 40 is divided into a time token 42 and a time token message key 44 as shown in FIG. 3.

In a preferred embodiment, HMAC-SHA-256 is used as the hash algorithm with a 64 bit source clock 12 and a 256 bit pre-shared key 14 as inputs. Other suitable hash algorithms that are familiar to persons having ordinary skill in this art may be employed to implement the present invention.

In one preferred embodiment, after hashing, the resulting cryptographic hash output 40 is 256 bits in length. The first 64 bits are used as the time token 42 and the remaining 192 bits are used as the time token message key 44. The source clock 12 is often specified in terms of seconds and fractions of a second. In the above embodiment, a 64 bit source clock 12 would likely be composed of a 32 bit seconds field and a 32 bit fractions of a second field. The precision in the fraction of a second field is determined by the precision generator of the source clock 12. For highly precise clock sources, for example where time is can be accurately expressed to the nanosecond, the source clock 12 should be expressed with lower precision for the purpose of token generation. The full precision fraction of a second field is used to generate the encrypted time 46.

The message encryptor 20 uses the time token message key 44 to encrypt the source clock 12 resulting in an encrypted time 46. If an original message 15 is present, the message encryptor 20 uses the time token message key 44 to encrypt the source clock 12 resulting in an encrypted message 47. Using a unique time token message key 44 for each encrypted time 46 and encrypted message 47 provides perfect forward secrecy, meaning that learning the time token message key 44 for a single encrypted time 46 does not affect the security of any other encrypted time 46. Information in addition to the source clock may be included and encrypted in the encrypted time 46.

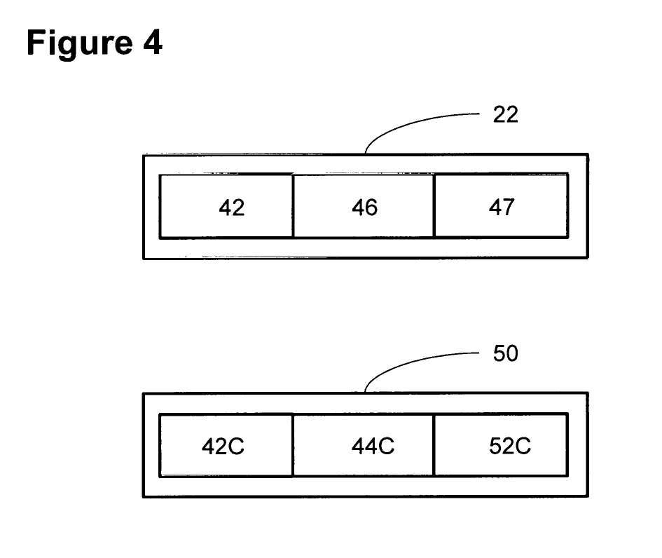

The filtered time encryptor 16 concatenates the time token 42, the encrypted time 46 and, if present, the encrypted message 47 to form a time token protected message 22 as shown in FIG. 4. The time token protected message 22 is then transmitted by the transmitter 24. In some embodiments, the encrypted message 47 may be communicated without the encrypted time 46.

Since the time token protected message 22 consists of a time token 42, an encrypted time 46 and optionally an encrypted message 47, it can be subsequently transmitted over an unprotected communications channel, such as being broadcast on an RF radio, sent over a computer network, communicated along an optical fiber or even communicated audibly as a sequence of tones.

The receiver 26 receives the transmitted time token protected message 22 and communicates it to the filtered time decryptor 28. The filtered time decryptor 28 filters received time token protected messages 22 using a time token filter 30. To determine which time token protected messages 22 are valid, the time token filter 30 maintains a time token cache 31, with each token cache entry 50 including a cached time token 42C, a cached clock value 52C used to generate the cached time token 42C and a cached time token message key 44C. The time token cache 31 is used to combat the effects of unreliable communications channel, clock drift and clock skew between the local clock 34 and the source clock 12 and variations in communications latency. To overcome these effects, a “window” where multiple clock values are recognizable is maintained. In one embodiment, a time token cache 31 maintaining 1000 cached time tokens 42C with a 100 μs resolution results in an overall time window of 0.1 seconds. Cached time tokens 42C that were generated using a time value that falls within this window will be recognized. The maintenance of cached time tokens 42C in the time token cache 31 involves the aging and removal of older tokens from the cache and the calculation and addition of new tokens to the cache. The time token cache 31 can be constructed using processor(s) and memory with a hash table data structure, using hardware content addressable memory (CAM) technology or other hardware technologies.

When the time token filter 30 receives a time token protected message 22, it attempts to locate matching cached time token 42C in the time token cache 31. If no cached matching time token 42C is found, the time token protected message 22 is discarded. If a matching cached time token 42C is found in the time token cache 31, the corresponding cached clock value 52C used to generate the cached time token 42C and the cached time token message key 44C are retrieved from the time token cache 31 and presented to the message decryptor 32 along with the encrypted time 46.

When a matching cached time token 42C is found, the message decryptor 32 decrypts the encrypted time 46 using the cached time token message key 44C to produce the decrypted clock 48. If an encrypted message 47 is present, the message decryptor 32 decrypts the encrypted message 47 using the cached time token message key 44C to produce the decrypted message 49. To insure proper decryption, the decrypted clock 48 should be compared against the cached clock value 52C used to generate the cached time token 42C. The cached clock value 52C used to generate the cached time token 42C should be the same as the decrypted clock 48 or a lower precision value of the decrypted clock 48. After determining that the decrypted clock 48 is the same as the cached clock value 52C used to generate the cached time token 42C, the token cache entry 50 is invalidated.

The decrypted clock 48 can be used to adjust the local clock 34. If additional message data was included and encrypted in the encrypted time 46, that message data is now available to the filtered time decryptor 28.

In order for the filtered time decryptor 28 to decrypt a time token protected message 22, its local clock 34 must be synchronized with the source clock 12 such that a received time token 42 falls within the window of time tokens 42 in the time token cache 31. In a preferred embodiment, a second source clock 12 is used with a much lower clock resolution and a wider window during the local clock 34 synchronization. For instance, the initialization clock resolution can be 1 second with a 300 second window. This allows a much wider range of clock values to be received and once one value is received and properly decrypted, the full resolution of the clock can be obtained from the decrypted clock 48.

### VI. Example of One Embodiment of a Secure Time Communication System

The following examples are provided to further explain to the reader the operation of the present invention. These example are supplied to enhance the reader's understanding, but are not presented to limit the scope of the embodiments of the present invention, or the scope of the Claims.

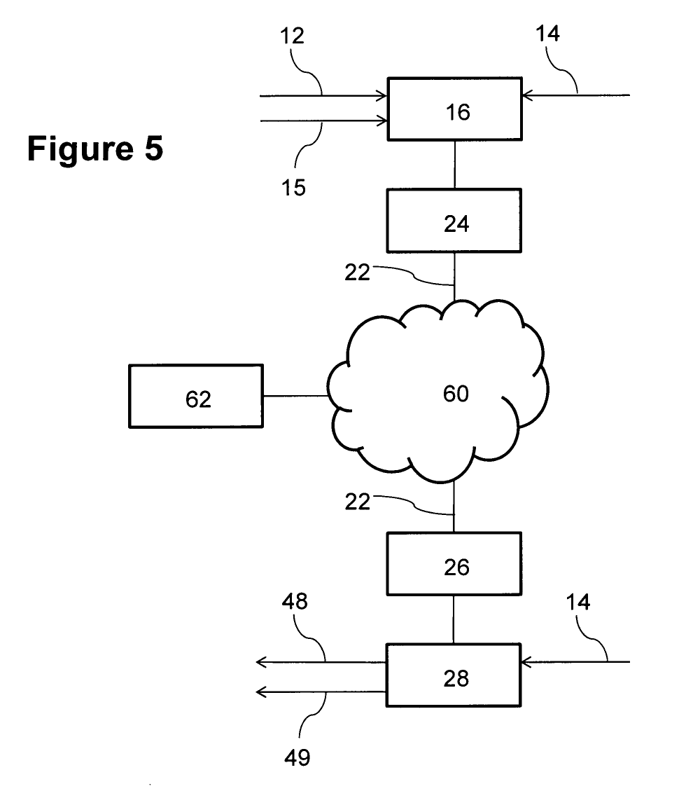

FIG. 5 shows one particular example of the present invention in operation, where time token protected messages 22 are being communicated across an unsecured communications channel 60. The time token protected messages 22 each contain an encrypted time 46 derived from a source clock 12. If the source clock 12 has a resolution of 0.000001 seconds, that clock is accurate to 1 microsecond or one millionth of a second. This is the accuracy of the source clock 12. To operate, the filtered time decryptor 28 maintains a time token cache 31, containing cached time tokens 42C. Maintaining the time token cache 31 is the process that, as time advances, removes cached time tokens 42C that fall outside of the time window and adds new cached time tokens 42C as the time window advances. This process is described in detail below. If the filtered time decryptor 28 uses the source clock 12 at the full resolution of 0.000001 seconds, the time token cache 31 would have to generate 1,000,000 cached time tokens 42C per second. While this is possible, it is very computationally expensive while adding little value to the solution. Therefore, in this implementation, the cached time tokens 42C are generated using a lower resolution clock. For the purpose of generating cached time tokens 42C, the resolution of the source clock 12 is reduced to 0.001 seconds, 1 millisecond or one thousandth of a second. Using the source clock 12 at this lower resolution now only requires the time token cache 31 to generate 1,000 cached time tokens 42C per second. Time values are often communicated in terms of seconds and fractions of a second. The seconds are counted from an agreed upon start time, known as an epoch, for example Jan. 6, 1980 at 12:00 AM. Thus, a time value of 12345678.123456 means 12345678 seconds since the beginning of epoch plus 0.123456 seconds. Using the above reference clock 12 example, the full resolution clock would be 12345678.123456 and the lower resolution clock would be 12345678.123.

The time token cache 31 in the filtered time decryptor 28 recognizes time cached tokens 42C that fall within a time window. In order to recognize a time token 42, a matching cached time token 42C must be in the time token cache 31. The time token cache maintains a series of cached time tokens 42C, with each cached time token 42C being generated with a different clock value. That is, the cached time tokens 42C in the time token cache 31 have been generated from a local clock 34 whose time is between time A and time B. For example, the invention may utilize a time window of one second. The time token cache 31 would generate cached time tokens 42C generated from a local clock 34 with a reduced resolution with clock values between 12345678.000 and 12345678.999.

In an alternative implementation, a one second time window would extend between the values of 12345678.500 to 12345679.499. The time values of the boundaries of the time window are arbitrary. Although a time window of one second has been used in this example, the time window can be any duration, as long as the time token cache 31 has the resources to maintain the entire time window. Those resources are sufficient computing power to generate cached time tokens 42C and the storage resources to store the resulting time token cache 31 entries. The time token cache 31 must maintain cached time tokens 42C to span the time window. For a one second time window and using a clock resolution of 0.001 seconds, one thousand cached time tokens 42C are required to span the window. For a longer duration time window of three seconds, three thousand cached time tokens 42C would be required at the same clock resolution of 0.001 seconds.

A time token 42 is derived from the cryptographic hash output 40 of a cryptographic hash function that uses a pre-shared key 14 and a local clock 34 at a reduced resolution as inputs. A shown in FIG. 3, a portion of the cryptographic hash output 40 is used as the time token 42 and a different portion is used as the time token message key 44. Both time tokens 42 and cached time tokens 42C are generated using the same process. When the time token cache 31 is generating cached time tokens 42C, it is also generating cached time token message keys 44C. Each token cache entry 50 contains, a cached time token 42C, a cached time token message key 44C and cached clock value 52C used to generate the cached time token 42C. This enables the time token cache 31 to provide the cached time token message key 44C and the cached clock value 52C when the corresponding cached time token 42C is matched.

Once the time token cache 31 has initially been populated with cached time tokens 42C, their associated cached time token message keys 44C and the cached clock value 52C used to generate each time token 42, the time token cache 31 must be maintained. The time window moves forward in time. The time window, as described by its boundaries, is constantly moving forward in time. Using the previous example of a time window of one second with the time boundaries of 12345678.000 and 12345678.999, the leading boundary is 12345678.999 and the trailing boundary is 12345678.000. Both of these boundaries advance at the same rate. When the leading boundary advances, new cached time tokens 42C must be calculated and placed in the time token cache 31. When the trailing boundary advances, cached time tokens 42C that are already in the time token cache 31 that are no longer within the time window are expired and are removed from the time token cache 31. For example, as the leading boundary advances from 12345678.999 to 12345679.000, a new cached time token 42C using the clock value of 12345679.000 is generated and placed in the time token cache 31. As the trailing boundary advances from 12345678.000 to 12345678.001, the cached time token 42C in the time token cache generated from the clock value 12345678.000 is expired and removed from the time token cache 31. This process repeats continuously to maintain the time token cache 31.

To securely communicate a source clock 12, a filtered time encryptor 16 uses a pre-shared key 14 and the value of the source clock 12 at a reduced resolution as inputs to a cryptographic hash function, producing the cryptographic hash output 40. A shown in FIG. 3, a portion of the cryptographic hash output 40 is used as the time token 42 and a different portion is used as the time token message key 44. The message key 44 is then used to encrypt the source clock 12 at full resolution. Additional message data may also be encrypted with the source clock. The result of the encryption is the encrypted time 46. The time token 42 and the encrypted time 46 are taken together to form a time token protected message 22. This is shown in FIG. 4. The time token protected message 22 is sent to a transmitter 24 which sends the time token protected message 22 via an unsecured communications channel 60 to a receiver 26.

A receiver 26 receives a time token protected message 22 and forwards it to the filtered time decryptor 28. The filtered time decryptor 28 takes the time token 42 from the time token protected message 22 and, using the time token 42 as the input search value to the time token cache 31, attempts to locate a matching cached time token 42C. If there is no matching cached time token 42C, then the time token protected message 22 is discarded. If there is a matching cached time token 42C in the time token cache 31, the associated cached time token message key 44C and cached clock value 52C used to generate the cached time token 42C are all retrieved. The encrypted time 46, obtained from the time token protect message 22 and the cached time token message key 44C are provided to the message decryptor 32. The message decryptor 32 decrypts the encrypted time 46. The output from the message decryptor should be the full resolution source clock value. The output from the message decryptor is compared to the cached clock value 52C used to generate the cached time token 42C. If both values, compared at the reduced resolution, do not match, the time token protected message 22 is discarded. For example, if the reduced resolution clock value is 12345678.123 and the decrypted source clock value is 12345678.123456, then the values match when compared at the reduced resolution. If the cached clock value 52C is again 12345678.123 and the decrypted source clock value is 234532.659342, the match fails and the time token protected message 22 is discarded. If both values, compared at the reduced resolution, match, then the decrypted encrypted time 46 is used as the decrypted clock 48 and the token cache entry 50 in the time token cache 31 is invalidated and removed from the time token cache 31.

As the time token protected message 22 traverses an unsecured communications channel 60, between the transmitter 24 and the receiver 26, it is subject to various forms of attack from an attacker 62. The time token protected message 22 has two layers of protection; each encrypted time 46 is encrypted with a different time token message key 44. This provides what is known as “perfect forward secrecy.” Perfect forward secrecy means that the discovery or compromise of a single message does not affect the secrecy of any other message. In the present invention, if the source clock 12 is accurately decrypted from encrypted time 46 by an attacker 62, the determination of the time token message key 44 used to encrypt that specific encrypted time 46 cannot be used to decrypt any other encrypted time 46. This makes brute force cryptographic attacks on the encrypted time message very difficult. The determination of the cached time token message key 44C is performed after a cached time token 42C has been located in the time token cache 31. This is the second layer of protection. The time token filter 30 and the time token cache 31 have been designed to make various forms of attack nearly impossible. In an embodiment using a time token 42 that is 64 bits long, the total number of unique time tokens is 2⁶⁴ or 18,446,744,073,709,551,616. Using the previous example of a time token cache 31 containing 1,000 tokens and their corresponding token cache entries 50, the probability of an attacker using a valid time token 42 is approximately 2.70894⁻¹⁴. Numerically, this is 0.000,000,000,000,027,089,4 or a chance of less than 1 in 28 quadrillion. The probability of an attacker using a valid time token can be reduced by increasing the size of the time token 42. Time tokens 42 are a portion of a cryptographic hash output 40. Cryptographic hash outputs 40 are irreversable, meaning their inputs cannot be determined from their outputs. Furthermore, there is no plaintext to compare against. The only way to determine of a cryptographic hash output 40 and thus a time token 42 is valid is to submit the time token 42 to the time token filter 30. This limits the number of attack attempts (guesses) to the maximum rate at which time tokens can be fed to the filtered time decryptor 28. For example, if the filtered time decryptor 28 can process one million tokens per second, the probability of an attacker guessing any valid time token 42 is still 2.70894⁻⁸. Numerically, this is 0.000,000,027,089,4 or a chance of less than one in 28 billion.

The cached time tokens 42C in the time token cache 31 are continuously being refreshed to stay within the time window. When the time window is one second, after one second, all of the cached time tokens 42C will have been refreshed. This forces the attacker to restart their attack, rendering the one million guesses that have already been made useless as the cached time tokens 42C in the time token cache 31 have completely changed. The time token filter 30 and the time token cache 31 have been designed to require the same low amount of computational effort to make the determination of if a time token 42 is found or if a time token 42 is not found within the time token cache 13. This is important because it allows the time token filter 30 to easily and quickly separate valid time tokens 42 from invalid time tokens 42.

Finally, in the event that an attacker 62 does produce a time token 42 that is in the time token cache 31, the attacker must still generate an encrypted time 46 that when decrypted using the cached time token message key 44C associated with the cached time token 42C, produces a clock value that matches the reduced resolution clock value used to generate the time token 42. This outcome is extremely unlikely.

All of these protections combine together to defend against various types of attack. Message spoofing attacks, where an attacker 62 creates a time token protected message 22, will fail by being filtered out by the time token filter 30. If, in the extremely unlikely case that a spoofed message is not filtered out by the time token filter, it will be filtered out by the message decryptor 32.

Another type of attack is the message replay attack. In a message replay attack, an attacker makes a copy of a valid message generated by a filtered time encryptor 16 and replays the copied message to the receiver 26. Replay attacks are protected against by invalidating a cached time token 42C in the time token cache 31 when a matching time token 42 is received. This invalidation causes the replayed time token protected message 22 to fail to be recognized, thus protecting the system from message replay attacks.

Another type of attack is the denial of service attack. In a denial of service attack, the attacker 62 attempts to overwhelm the target with high volumes of data. The time token filter 30 and the time token cache 31 have been designed to require the same low amount of computational effort to make the determination of if a time token 42 is found or if a time token 42 is not found within the time token cache 13. This is important because it allows the time token filter 30 to easily and quickly separate valid time tokens 42 from invalid time tokens 42, as is the case during a denial of service attack.

Another type of attack is a the cryptographic performance attack. In a cryptographic performance attack, the attacker 62 sends messages designed to trigger the execution of computationally expensive cryptographic algorithms. This is a form of message spoofing and denial of service attacks. In the present invention, time token protected messages 22 generated by the attacker 62 intended to place additional load on the message decryptor 32 are filtered out by the time token filter 30 as described above. The time token filter 30 in conjunction with the time token cache 31 reduce cryptographic performance attacks to a denial of service or message spoofing attack.

Another type of attack is message delay manipulation. In message delay manipulation, a valid time token protected message 22 produced by a filtered time encryptor 16 is delayed during its traversal of the unsecured communications channel 60. If the delayed time token protected message 22 is received when the time value used to generate the time token 42 is still within the time window, it will be received normally. If the attacker 62 has delayed the time token protected message 22 enough so that it falls outside of the time window, then the time token 42 will be unrecognized. In one embodiment of the present invention, once a time token cache entry 50 has expired, the token cache entry 50 can be marked invalid but is not removed from the time token cache 31. This allows the time token filter 30 to recognize and detect time token protected messages 22 that have been delayed outside of the time window.

### VII. Process Flow for One Embodiment of a Secure Time Communication System

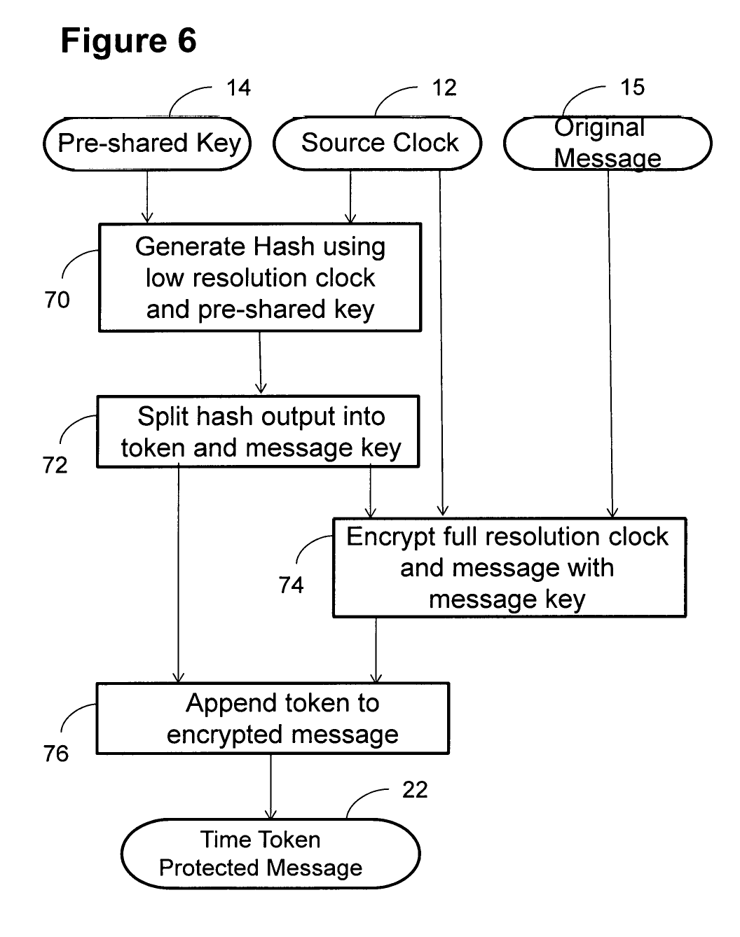

FIG. 6 shows a flowchart illustrating how a time token protected message is created. In FIG. 6, Step 1 70 a pre-shared key 14 and a source clock 12 are used to as inputs to a hash function. The resolution of the source clock 12 is changed to a previously specified reduced value and a cryptographic hash output 40 is generated. In FIG. 6, Step 2 72, the cryptographic hash output 40 is split into a time token 42 and a message key 44. In FIG. 6, Step 3 74 the message key 44 is used to encrypt the source clock 12 producing an encrypted time 46. For this step, the source clock 12 is used at its original resolution. Optionally, an original message 15 may be encrypted producing an encrypted message 47. In FIG. 6, Step 4 76, a time token protected message 22 is created by appending the time token 42 to the encrypted time 46. Optionally, an encrypted message 47 may also be appended to produce the time token protected message 22.

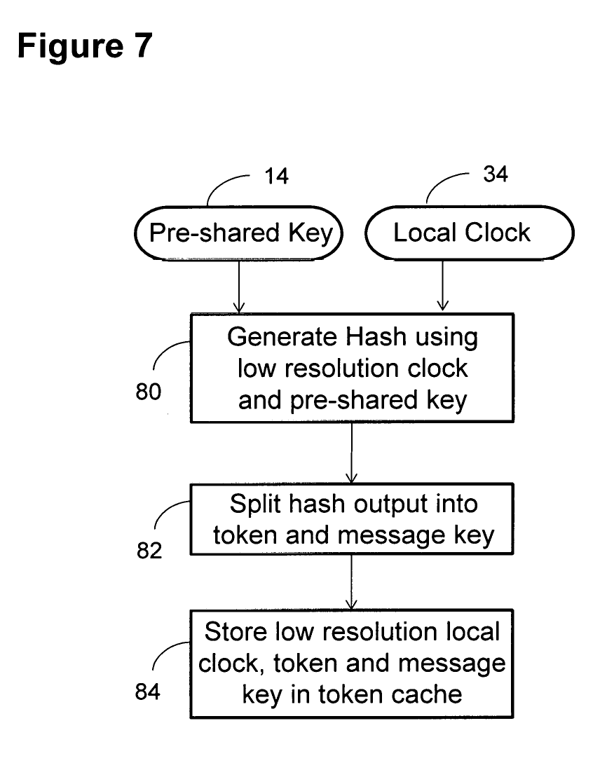

FIG. 7 shows a flowchart illustrating how a token cache entry 50 is created. In FIG. 7, Step 1 80, a pre-shared key 14 and a local clock 34 are used to as inputs to a hash function. The resolution of the local clock 34 is changed to a previously specified reduced value and a cryptographic hash output 40 is generated. In FIG. 7, Step 2 82, the cryptographic hash output 40 is split into a time token 42 and a message key 44. In FIG. 7, Step 3 84, the clock value used as input to the cryptographic hash function is stored as a cached clock value 52C in a token cache entry 50 with the cached time token 42C and the cached time token message key 44C. The token cache entry 50 is added to the token cache 31.

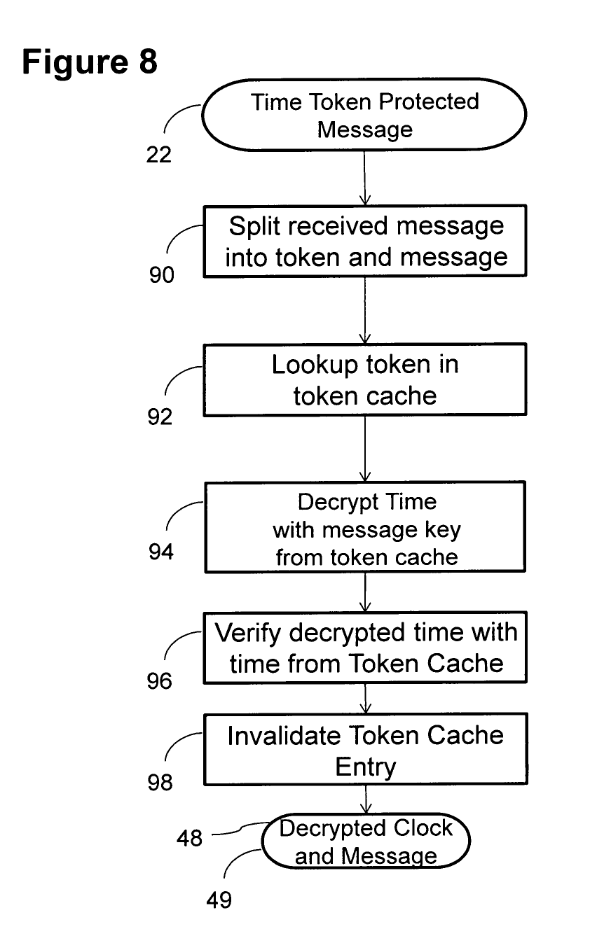

FIG. 8 shows a flowchart illustrating how a time token protected message 22 is filtered and decrypted. In FIG. 8, Step 1 90, a time token protected message 22 is separated into its constituent parts; a time token 42, an encrypted time 46, and, optionally, an encrypted message 47. In FIG. 8, Step 2 92, the time token 42 is used to locate a token cache entry 50 with a matching cached time token 42C in the time token cache 31. In FIG. 8, Step 3 94, the encrypted time 46 is decrypted using the cached time token message key 44C from the matched token cache entry 50 producing a decrypted clock 48. Optionally, an encrypted message 47 can also be decrypted using the cached time token message key 44C from the matched token cache entry 50 producing a decrypted original message 49. In FIG. 8, Step 4 96, the decrypted clock 48 should be the full resolution source clock 12 value. The decrypted clock 48 is compared to the cached clock value 52C in the matched token cache entry 50. If both values, compared at the reduced resolution match, then the decrypted encrypted time 46 is verified. In FIG. 8, Step 5 98, the matched token cache entry 50 in the time token cache 31 is invalidated to prevent reuse. The resulting decrypted clock 48 is presented as valid. Optionally, the decrypted original message 49 is presented as valid.

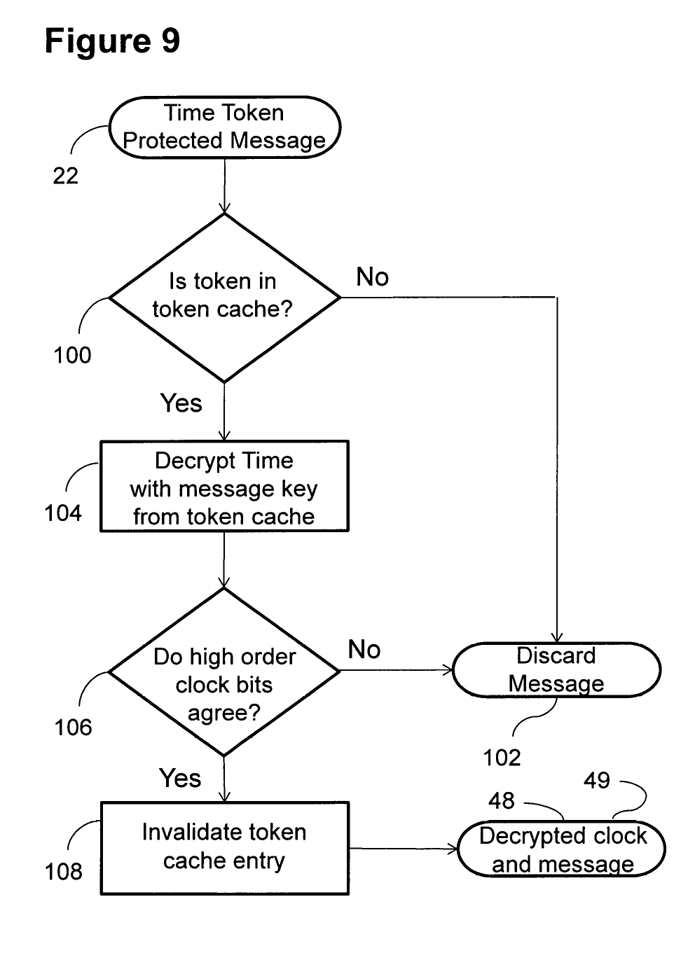

FIG. 9 shows a flowchart illustrating how time token protected messages 22 are filtered and discarded. In FIG. 9, Step 1 100, a time token 42 from a time token protected message 22 is used to locate a token cache entry 50 with a matching cached time token 42C in the time token cache 31. If a token cache entry 50 with a matching cached time token 42C cannot be located, the time token protected message 22 is processed by FIG. 9, Step 2 102 where the time token protected message 22 is discarded. In FIG. 9, Step 3 104, the encrypted time 46 is decrypted using the cached time token message key 44C from the matched token cache entry 50 producing a decrypted clock 48. Optionally, an encrypted message 47 can also be decrypted using the cached time token message key 44C from the matched token cache entry 50 producing a decrypted original message 49. In FIG. 9, Step 4 106, the decrypted clock 48 should be the full resolution source clock 12 value. The decrypted clock 48 is compared to the cached clock value 52C in the matched token cache entry 50. If both values, compared at the reduced resolution do not match, the time token protected message 22 is processed by FIG. 9, Step 2 102 where the time token protected message 22 is discarded. In FIG. 9, Step 5 108, the matched token cache entry 50 in the time token cache 31 is invalidated to prevent reuse. The resulting decrypted clock 48 is presented as valid. Optionally, the decrypted original message 49 is presented as valid.

### VIII. Authenticated Time Communications

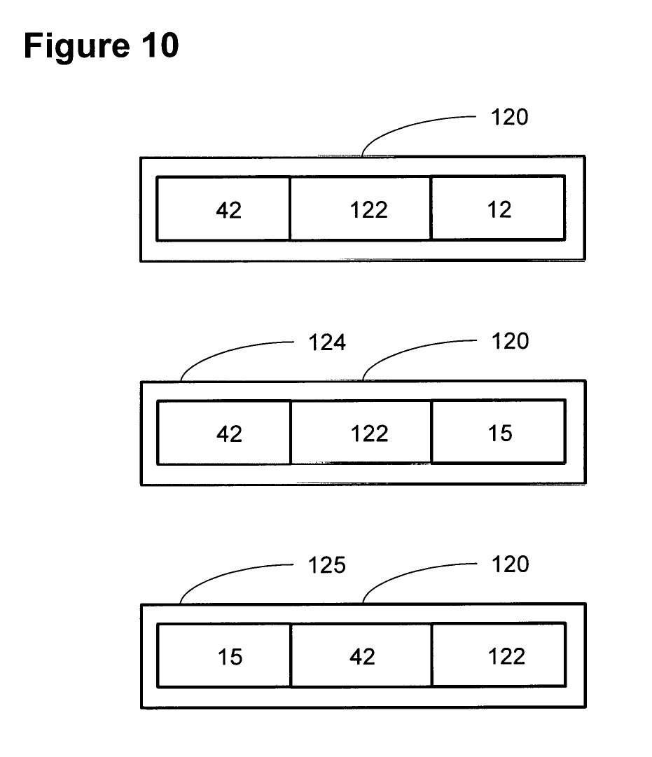

FIG. 10 shows three schematics of a time token authenticated message 120. A time token authenticated message 120 in first embodiment A 121 is composed of a time token 42, a message authentication code 122 and a source clock 12. A time token authenticated message 120 in alternate embodiment B is composed of a time token 42, a message authentication code 122 and an original message 15. A time token authenticated message 120 in retrofit authenticated message format 125 is composed of an original message 15, a time token 42 and a message authentication code 122. In the retrofit authenticated message format 125, the original message 15 is communicated first. After the original message 15, the time token 42 and the message authentication code 122 can be communicated in any order.

### IX. Process Flow for an Authenticated Time Communication System

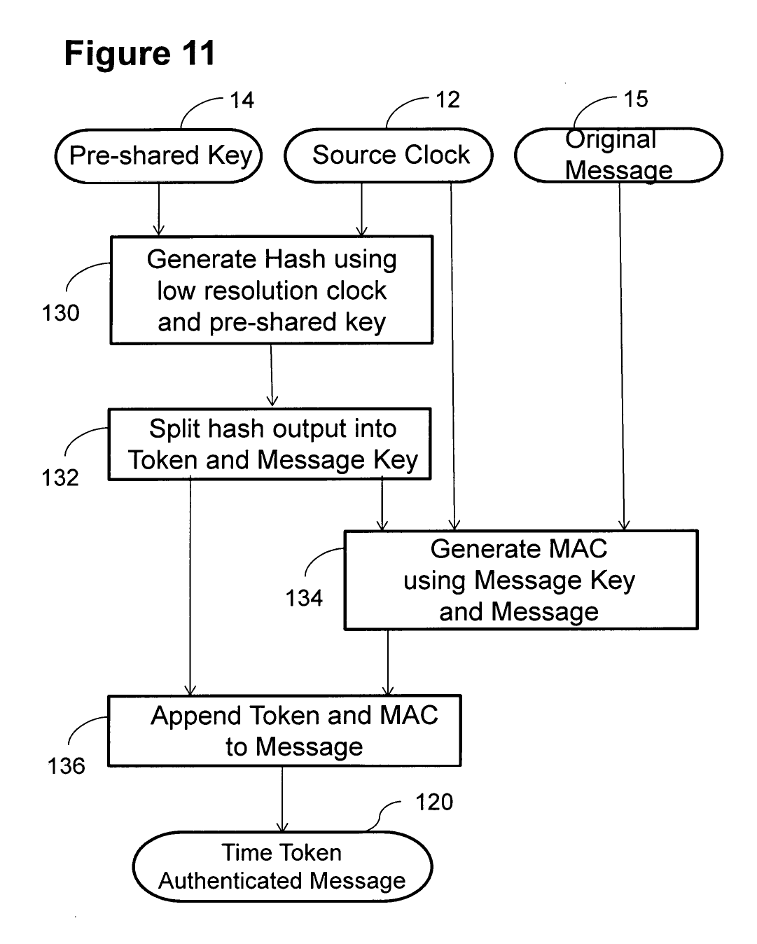

FIG. 11 shows a flowchart illustrating how a time token authenticated message 120 is created. In FIG. 11, Step 1 130 a pre-shared key 14 and a source clock 12 are used to as inputs to a hash function. The resolution of the source clock 12 is changed to a previously specified value and a cryptographic hash output 40 is generated. In FIG. 11, Step 2 132, the cryptographic hash output 40 is split into a time token 42 and a message key 44. In FIG. 11, Step 3 134 the message key 44 is used to generate a message authentication code 122 of the source clock 12. Optionally, the message key 44 is used to generate a message authentication code 122 of the original message 15. In FIG. 11, Step 4 136, a time token authentication message 120 is created by appending the time token 42 and the message authentication code 122 to the source clock 12. Optionally, a time token authentication message 120 is created by appending the time token 42 and the message authentication code 122 to the original message 15.

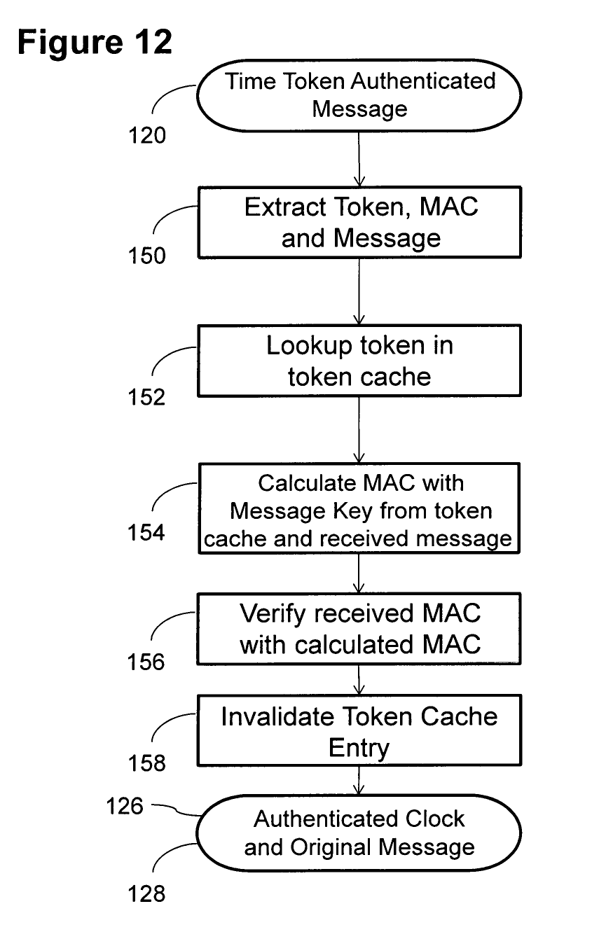

FIG. 12 shows a flowchart illustrating how a time token authenticated message 120 is filtered and authenticated. In FIG. 12, Step 1 150, a time token authenticated message 120 is separated into its constituent parts; a time token 42, a message authentication code 122, and a source clock 12. In an alternate embodiment, a time token authenticated message 120 is separated into its constituent parts; a time token 42, a message authentication code 122, and an original message 15. In FIG. 12, Step 2 152, the time token 42 is used to locate a token cache entry 50 with a matching cached time token 42C in the time token cache 31. In FIG. 12, Step 3 154 the cached time token message key 44C from the token cache entry 50 is used to generate a local message authentication code 122L of the source clock 12. Optionally, the cached time token message key 44C from the token cache entry 50 is used to generate a local message authentication code 122L of the original message 15. In FIG. 12, Step 4 156 the generated local message authentication code 122L is compared with the message authentication code 122 obtained from the time token authenticated message 120 in FIG. 12, Step 1 150. If the local message authentication code 122L matches the message authentication code 122, then the authentication of the received time token authenticated message 120 is confirmed and the received message has been authenticated. In FIG. 12, Step 5 158, the matched token cache entry 50 in the time token cache 31 is invalidated to prevent reuse. The source time 12 is authenticated resulting in the authenticated source time 128. Optionally, the original message 15 is authenticated resulting in the authenticated original message 126.

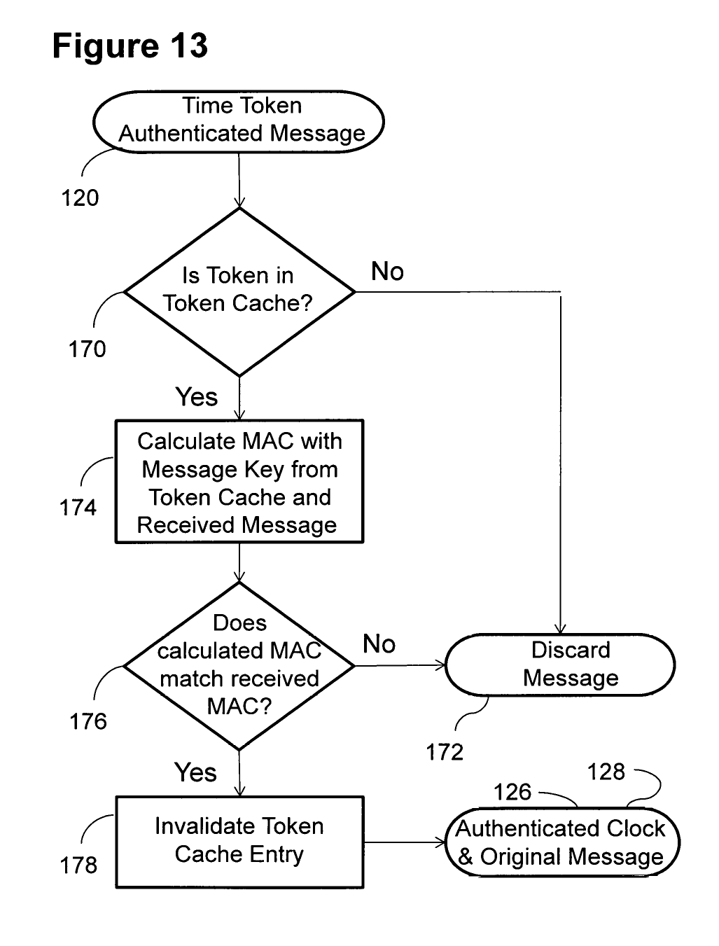

FIG. 13 shows a flowchart illustrating how time token authenticated messages 120 are filtered and discarded. In FIG. 13, Step 1 170, a time token 42 from a time token authenticated message 120 is used to locate a token cache entry 50 with a matching cached time token 42C in the time token cache 31. If a token cache entry 50 with a matching cached time token 42C cannot be located, the time token authenticated message 120 is processed by FIG. 13, Step 2 172 where the time token authenticated message 120 is discarded. In FIG. 13, Step 3 174, the cached time token message key 44C from the token cache entry 50 is used to generate a local message authentication code 122L of the source clock 12. Optionally, the time token message key 44C from the token cache entry 50 is used to generate a local message authentication code 122L of the original message 15. In FIG. 13, Step 4 176, the generated local message authentication code 122L is compared with the message authentication code 122 obtained from the time token authenticated message 120 in FIG. 12, Step 1 150. If the local message authentication code 122L does not match the message authentication code 122, then the authentication of the received time token authenticated message 120 fails and the time token authenticated message 120 is processed by FIG. 13, Step 2 172 where the time token authenticated message 120 is discarded. If the local message authentication code 122L matches the message authentication code 122, then the authentication of the received time token authenticated message 120 is confirmed and the received message has been authenticated. In FIG. 13, Step 5 178, the matched token cache entry 50 in the time token cache 31 is invalidated to prevent reuse. The source time 12 is authenticated resulting in the authenticated source time 128. Optionally, the original message 15 is authenticated resulting in the authenticated original message 126.

### X. A Description of One Alternative Embodiment of the Invention

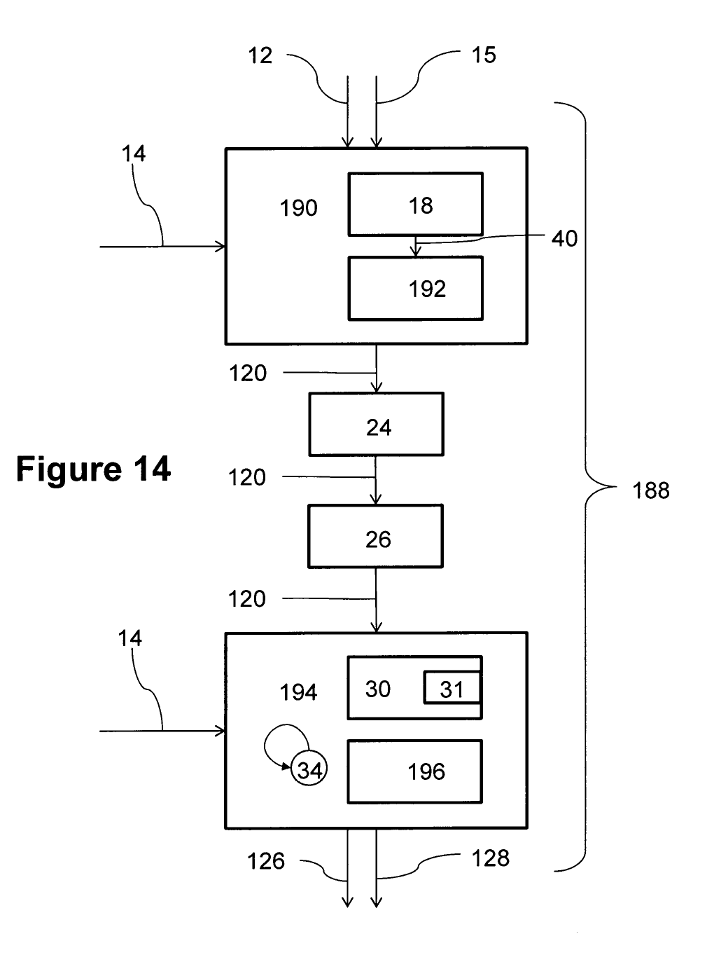

In one embodiment of the invention, shown in FIG. 14, a source clock 12 and a pre-shared key 14 is presented as inputs to a filtered time MAC generator 190. An original message 15 may optionally be presented to the filtered time MAC generator 190. The filtered time MAC generator 190 contains a time token generator 18, providing a means for a time token generator. The filtered time MAC generator 190 also contains a message authentication code generator 192, providing a means for message authentication code generator. The filtered time MAC generator 190 is connected to a transmitter 24. The transmitter is used to transmit time token authenticated messages 120 to a receiver 26.

A receiver 26 is connected to a filtered time authenticator 194. The filtered time authenticator 194 contains a time token filter 30 providing a means for a time token filter. The time token filter 30 contains a time token cache 31. The filtered time authenticator 194 also contains a message authentication code authenticator 196, providing a means for a message authentication code authenticator. The filtered time authenticator 194 also contains a local clock 34.

Within the filtered time MAC generator 190, the time token generator 18 takes the source clock 12 and the pre-shared key 14 and using a cryptographic hash algorithm, produces a cryptographic hash output 40. The cryptographic hash output 40 is divided into a time token 42 and a time token message key 44 as shown in FIG. 3.

In a preferred embodiment, HMAC-SHA-256 is used as the hash algorithm with a 64 bit source clock 12 and a 256 bit pre-shared key 14 as inputs. Other suitable hash algorithms that are familiar to persons having ordinary skill in this art may be employed to implement the present invention.

After hashing, the resulting cryptographic hash output 40 is 256 bits in length. The first 64 bits are used as the time token 42 and the remaining 192 bits are used as the time token message key 44. The source clock 12 is often specified in terms of seconds and fractions of a second. In the above embodiment, a 64 bit source clock 12 would likely be composed of a 32 bit seconds field and a 32 bit fractions of a second field. The precision in the fraction of a second field is determined by the precision generator of the source clock 12. For highly precise clock sources, for example where time is can be accurately expressed to the nanosecond, the source clock 12 should be expressed with lower precision for the purpose of token generation.

The message authentication code generator 192 uses the time token message key 44 to generate a message authentication code 122 of the source clock 12. Optionally, the message key 44 is used to generate a message authentication code 122 of the original message 15. Using a unique time token message key 44 for each message authentication code 122 provides perfect forward secrecy, meaning that learning the time token message key 44 for a single time token authenticated message 120 does not affect the security of any other time token authenticated message time 120.

The filtered time MAC generator 190 creates a time token authentication message 120 by appending the time token 42 and the message authentication code 122 to the source clock 12. Optionally, a time token authentication message 120 is created by appending the time token 42 and the message authentication code 122 to the original message 15. The time token authenticated message 190 is then transmitted by the transmitter 24.

Since the time token authenticated message 120 consists of a time token 42, a message authentication code 122 and a source clock 12 or an original message 15, it can be subsequently transmitted over an unprotected communications channel, such as being broadcast on an RF radio, sent over a computer network, communicated along an optical fiber or even communicated audibly as a sequence of tones.

The receiver 26 receives the transmitted time token authentication message 120 and communicates it to the filtered time authenticator 194. The filtered time authenticator 194 first filters received time token authenticated messages 120 using a time token filter 30. To determine which time token authenticated messages 120 are valid, the time token filter 30 maintains a time token cache 31 of token cache entries 50 each including a cached time token 42C, the clock value 52 used to generate the cached time token 42C and the cached time token message key 44C. Multiple cached time tokens 42C are used in the time token cache 31 to combat the effects of unreliable communications channel, clock drift and clock skew between the local clock 34 and the source clock 12 and variations in communications latency. To overcome these effects, a “window” where multiple clock values are recognizable is maintained. In one embodiment, a time token cache 31 maintaining 1000 time tokens 42 with a 100 μs resolution results in an overall time window of 0.1 seconds. Cached time tokens 42C that were generated using a time value that falls within this window will be recognized. The maintenance of cached time tokens 42C in the time token cache 31 involves the aging and removal of older tokens from the cache and the calculation and addition of new tokens to the cache. The time token cache 31 can be constructed using processor(s) and memory with a hash table data structure, using hardware content addressable memory (CAM) technology or other hardware technologies.

Cached time tokens 42C are aged or removed from the token cache after a specified amount of time to place an upper bound on the length of time that a message will be considered valid. Without aging, old messages could be delayed indefinitely by an attacker and that at a time of the attacker's choosing, released and providing false timing information to the receiving system.

When the time token filter 30 receives a time token authenticated message 120, a time token 42 from the time token authenticated message 120 is used to locate a token cache entry 50 with a matching cached time token 42C in the time token cache 31. If a token cache entry 50 with a matching cached time token 42C cannot be located, the time token authenticated message 120 is discarded. If a token cache entry 50 with a matching cached time token 42C is located, token cache entry 50 containing the cached time token 42C, the cached clock value 52C used to generate the cached time token 42C and the associated cached time token message key 44C are retrieved from the time token cache 31 and presented to the message authentication code authenticator 196 along with the source clock 12 or optionally the original message 15.

The message authentication code authenticator 196 uses the cached time token message key 44C from the token cache entry 50 is used to generate a local message authentication code 122L of the source clock 12. Optionally, the cached time token message key 44C from the token cache entry 50 is used to generate a local message authentication code 122L of the original message 15. The generated local message authentication code 122L is compared with the message authentication code 122 obtained from the time token authenticated message 120. If the local message authentication code 122L does not match the message authentication code 122, then the authentication of the received time token authenticated message 120 fails and the time token authenticated message 120 is discarded. If the local message authentication code 122L matches the message authentication code 122, then the authentication of the received time token authenticated message 120 is confirmed and the received message has been authenticated. The matched token cache entry 50 in the time token cache 31 is invalidated to prevent reuse. The source time 12 is authenticated resulting in the authenticated source time 128. Optionally, the original message 15 is authenticated resulting in the authenticated original message 126.

In order for the filtered time authenticator 194 to authenticate a time token authenticated message 120, its local clock 34 must be synchronized with the source clock 12 such that a received time token 42 falls within the window of cached time tokens 42C in the time token cache 31. In a preferred embodiment, a second source clock 12 is used with a much lower clock resolution and a wider window during the local clock 34 synchronization. For instance, the initialization clock resolution can be 1 second with a 300 second window. This allows a much wider range of clock values to be received and once one value is received and properly authenticated, the full resolution of the clock can be obtained from the authenticated time 128.

### XI. Examples of Authenticated Time

The following examples are provided to further explain to the reader the operation of the present invention. These example are supplied to enhance the reader's understanding, but are not presented to limit the scope of the embodiments of the present invention, or the scope of the Claims.

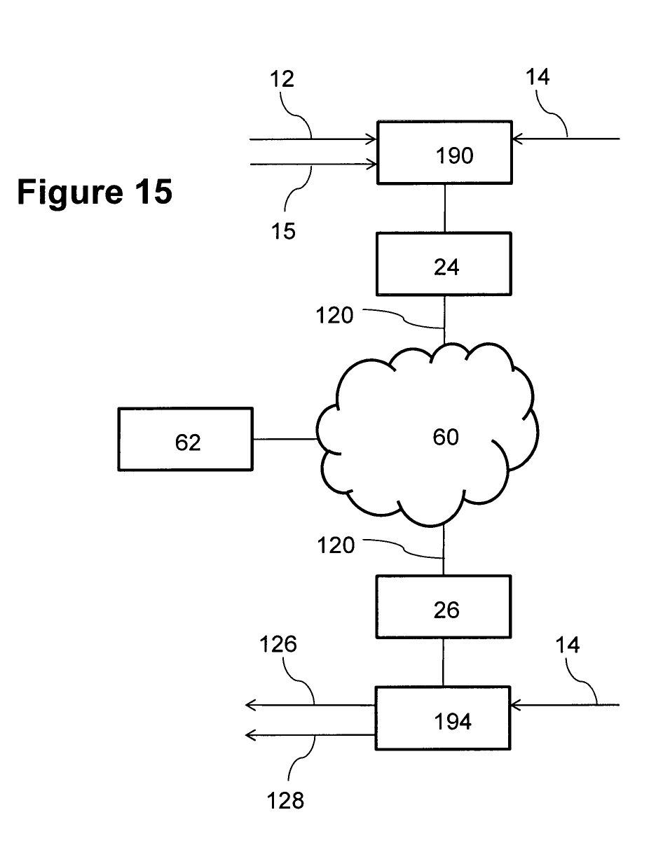

FIG. 15 shows one particular example of the present invention in operation, where time token protected authenticated messages 120 are being communicated across an unsecured communications channel 60. The time token authenticated messages 120 each contain an message authentication code 122 generated from an original message 15 and a time token message key 44. To operate, the filtered time authenticator 194 maintains a time token cache 31, containing cached time tokens 42C. Maintaining the time token cache 31 operates as described in Section IV.

To communicate a source clock 12 with authentication, a filtered time MAC generator 190 uses a pre-shared key 14 and the value of the source clock 12 at a reduced resolution as inputs to a cryptographic hash function, producing the cryptographic hash output 40. A shown in FIG. 3, a portion of the cryptographic hash output 40 is used as the time token 42 and a different portion is used as the time token message key 44. The message key 44 is then used to generate a message authentication code 122 of the source clock 12. An alternate embodiment uses the message key 44 to generate a message authentication code 122 of the original message 15. The time token 42, the generated message authentication code 122 and the source clock 12 are taken together to form a time token authenticated message 120. In an alternate embodiment, the time token 42, the generated message authentication code 122 and the original message 15 are taken together to form the time token authenticated message 120. This is shown in FIG. 10. The time token authenticated message 120 is sent to a transmitter 24 which sends the time token authenticated message 120 via an unsecured communications channel 60 to a receiver 26.

A receiver 26 receives a time token authenticated message 120 and forwards it to the filtered time authenticator 194. The filtered time authenticator 194 takes the time token 42 from the time token authenticated message 120 and sends it to the time token filter 30. When the time token filter 30 receives a time token authenticated message 120, a time token 42 from the time token authenticated message 120 is used to locate a token cache entry 50 with a matching cached time token 42C in the time token cache 31. If a token cache entry 50 with a matching cached time token 42C cannot be located, the time token authenticated message 120 is discarded. If a token cache entry 50 with a matching cached time token 42C is located, the corresponding cached clock value 52C used to generate the matching cached time token 42C and the associated cached time token message key 44C are retrieved from the time token cache 31 and presented to the message authentication code authenticator 196 along with the source clock 12 or optionally the original message 15.

The message authentication code authenticator 196 uses the cached time token message key 44C from the token cache entry 50 is used to generate a local message authentication code 122L of the source clock 12. Optionally, the cached time token message key 44C from the token cache entry 50 is used to generate a local message authentication code 122L of the original message 15. The generated local message authentication code 122L is compared with the message authentication code 122 obtained from the time token authenticated message 120. If the local message authentication code 122L does not match the message authentication code 122, then the authentication of the received time token authenticated message 120 fails and the time token authenticated message 120 is discarded. If the local message authentication code 122L matches the message authentication code 122, then the authentication of the received time token authenticated message 120 is confirmed and the received message has been authenticated. The matched token cache entry 50 in the time token cache 31 is invalidated to prevent reuse. The source time 12 is authenticated resulting in the authenticated source time 128. Optionally, the original message 15 is authenticated resulting in the authenticated original message 126. As the time token authenticated message 120 traverses an unsecured communications channel 60, between the transmitter 24 and the receiver 26, it is subject to various forms of attack from an attacker 62. Each time token authenticated message 120 has two layers of protection. The first layer of protection is the use of a message authentication code 122 that uses a unique time token message key 44. Using a unique time token message key 44 provides what is known as “perfect forward secrecy.” Perfect forward secrecy means that the discovery or compromise of a single message does not affect the authentication of any other message. In the present invention, if the source clock is accurately authenticated from the message authentication code 122 by an attacker 62, the determination of the time token message key 44 used to authenticate a specific message authentication code 122 cannot be used to authenticate or generate other valid message authentication codes 122. This makes brute force cryptographic attacks on authenticated time messages very difficult. The determination of the cached time token message key 44C is performed after a cached time token 42C has been located in the time token cache 31. This is the second layer of protection. The time token filter 30 and the time token cache 31 have been designed to make various forms of attack nearly impossible. If we are using a time token 42 that is 64 bits long, the total number of unique time tokens 42 is 2⁶⁴ or 18,446,744,073,709,551,616. Using the above example of a time token cache 31 using 1,000 tokens, the probability of an attacker using a valid time token 42 is approximately 2.70894⁻¹⁴. Numerically, this is 0.000,000,000,000,027,089,4 or a chance of less than 1 in 28 quadrillion. The probability of an attacker using a valid time token can be reduced by increasing the size of the time token 42. Time tokens 42 are a portion of a cryptographic hash output 40. Cryptographic hash outputs 40 are irreversible; the inputs cannot be determined from the outputs. The only way to determine of a cryptographic hash output 40 and thus a time token 42 is valid is to submit the time token 42 to the time token filter 30. This thus limits the number of attack attempts (guesses) to the maximum rate at which time tokens can be fed to the filtered time authenticator 194. For example, if the filtered time authenticator 194 can process one million tokens per second, the probability of an attacker guessing any valid time token 42 is still 2.70894⁻⁸. Numerically, this is 0.000,000,027,089,4 or a chance of less than one in 28 billion.

The cached time tokens 42C in the time token cache 31 are continuously being refreshed to stay within the time window. When the time window is one second, after one second, all of the cached time tokens 42C will have been refreshed. This forces the attacker to restart their attack, rendering the one million guesses that have already been made useless as the cached time tokens 42C in the time token cache 31 have completely changed. Any information gained from previous guesses is lost. The time token filter 30 and the time token cache 31 have been designed to require the same low amount of computational effort if a time token 42 is found or if a time token 42 is not found within the time token cache 31. This is important because it allows the time token filter 30 to easily and quickly separate valid time tokens 42 from invalid time tokens 42. A valid time token 42 is a time token 42 that matches a cached time token 42C in the time token cache 31.

Finally, in the event that an attacker 62 does produce a time token 42 that is in the time token cache 31, the attacker must still generate a message authentication code 122 that when authenticated using the cached time token message key 44C associated with the cached time token 42C, produces a valid message authentication code 122. This outcome is extremely unlikely.

All of these protections combine together to defend against various types of attack. Message spoofing attacks, where an attacker 62 creates a time token authenticated message 120, will fail by being filtered out by the time token filter 30. If, in the extremely unlikely case that a spoofed message is not filtered out by the time token filter, it will be filtered out by the message authentication code authenticator 196.

Another type of attack is the message replay attack. In a message replay attack, an attacker makes a copy of a valid message generated by a filtered time MAC generator 190 and replays the copied message to the receiver 26. Replay attacks are protected against by invalidating a time token 42 in the time token cache 31 when a matching time token 42 is received. This invalidation causes the replayed time token authenticated message 120 to fail to be recognized, thus protecting the system from message replay attacks.

Another type of attack is the denial of service attack. In a denial of service attack, the attacker 62 attempts to overwhelm the target with high volumes of data. The time token filter 30 and the time token cache 31 have been designed to require the same low amount of computational effort to determine if a time token 42 is found or if a time token 42 is not found within the time token cache 31. This is important because it allows the time token filter 30 to easily and quickly separate valid time tokens 42 from invalid time tokens 42, as is the case during a denial of service attack.

Yet another type of attack is a the cryptographic performance attack. In a cryptographic performance attack, the attacker 62 sends messages designed to trigger the execution of computationally expensive cryptographic algorithms. This is a form of message spoofing and denial of service attacks. In the present invention, time token authenticated messages 120 generated by the attacker 62 intended to place additional load on the message authentication code authenticator 196 are filtered out by the time token filter 30 as described above. The time token filter 30 in conjunction with the time token cache 31 reduce cryptographic performance attacks to a denial of service or message spoofing attack.

Still another type of attack is message delay manipulation. In message delay manipulation, a valid time token authenticated message 120 produced by a filtered time MAC generator 190 is delayed during its traversal of the unsecured communications channel 60. If the delayed time token authenticated message 120 is received when the time value used to generate the time token 42 is still within the time window, it will be received normally. If the attacker 62 has delayed the time token authenticated message 120 enough so that it falls outside of the time window, then the time token 42 will be unrecognized. In one embodiment of the present invention, once a time token cache entry 50 has expired, the token cache entry 50 can be marked invalid but is not removed from the time token cache 31. This allows the time token filter 30 to recognize and detect time token authenticated messages 120 that have been delayed outside of the time window.

### XII. Vulnerabilities of Timing Communications

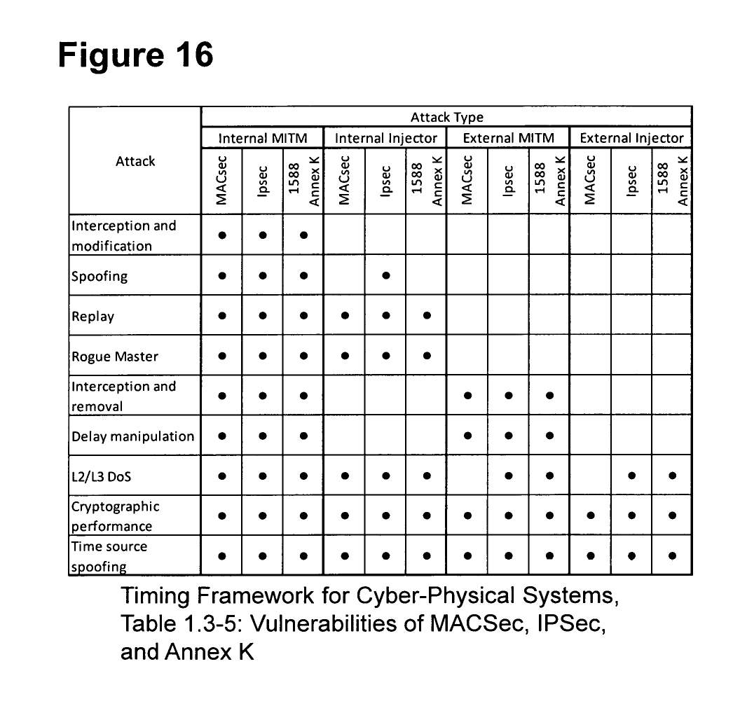

FIG. 16 is a chart showing vulnerabilities of present security methods to different forms of attack. FIG. 16 is taken from the NIST document “Timing Framework for Cyber-Physical Systems, Technical Annex, Draft 0.8” dated September 2015. The accepted security approaches MACSec (IEEE standard 802.1AE), IPsec (IETF RFC 4301) and IEEE Standard 1588, Annex K are shown in the attach scenarios of Internal Man-In-The-Middle (MITM), Internal Injector, External MITM and External Injector. The specific attack type of each scenario is shown along the left hand side: Interception and modification, spoofing, replay, rogue master, interception and removal, delay manipulation, L2/L3 denial of service (DoS), cryptographic performance, time source spoofing. Each dot in FIG. 16 represents a vulnerability to the indicated type of attack.

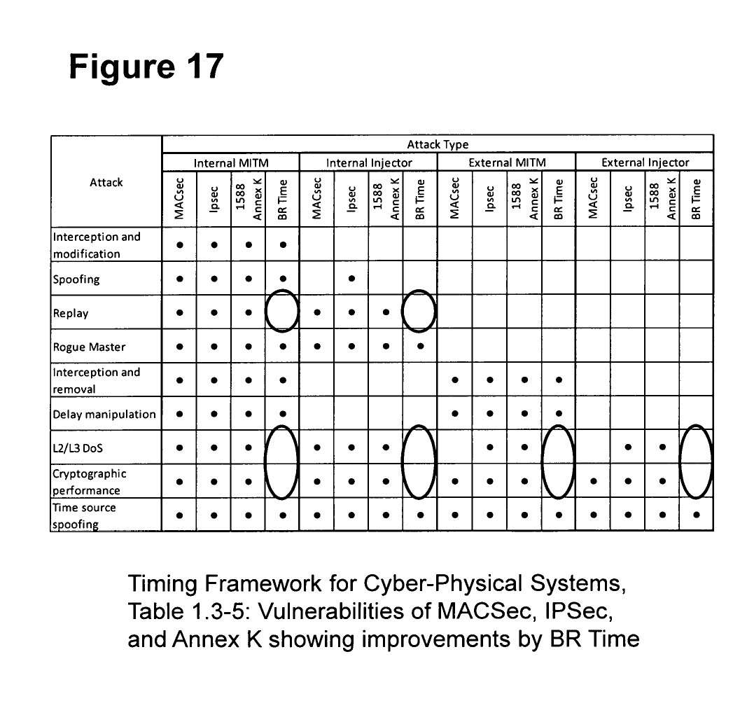

FIG. 17 is a chart showing vulnerabilities of present security methods and the present invention to different forms of attack. FIG. 17 contained the information presented in FIG. 16 with the present invention added a columns labeled “BR Time”. The dark ovals show the specific vulnerabilities mitigated by the present invention. Specifically, the present invention blocks replay, L2/L3 DoS and cryptographic performance attacks for Internal MITM and Internal Injector scenarios. The present invention also blocks L2/L3 DoS and cryptographic performance attacks for External MITM and External Injector scenarios.

### XIII. Additional Embodiments

For timing protocols that require the sending of more that a single packet during the time period described by a single low resolution clock tick, the time token generator includes an additional input to the cryptographic hash. The additional input indicates the event number that falls within a single low resolution clock tick. For example, using a low resolution clock that ticks every microsecond ( 1/1000 of a second) if we need to send three packets during a single microsecond, then we need to insure each time token encrypted message or each time token authenticated message will generate a unique time token. Adding an event number to the cryptographic hash calculation insures that multiple time tokens generated within the same clock tick will have different token values. When the low resolution clock ticks, the event number is set to zero. When a time token is generated, the event number is incremented. To accommodate this, the time token cache must also generate tokens using an event number. The time token cache generates time tokens for each time value and for each event number up to a predetermined maximum number of events. For example, if we wish to allow 10 time token events per low resolution clock tick, then for each clock tick we must calculate 10 time tokens, using event number 1-10. This is approach of using event numbers is much more efficient that increasing the resolution of the clock.

The present invention can be used to secure timing communications of security devices that rely of time for their correct operation. This includes devices that employ Transmission Access Control (TAC) and Statistical Object Identification (SOI).

### XIV. Glossary

The following Glossary is provided to teach the reader about the present invention, and to assist them in their comprehension of the Specification and Claims. The definitions are supplied to enhance the reader's understanding, but are not presented to limit the scope of the embodiments of the present invention, or the scope of the Claims. Other suitable definitions may be found in scientific literature pertaining to this field.
Additional Message Data—Non-timing data communicated in a message containing timing data.
Cache—a hardware or software component that stores data so future requests for that data can be served faster; the data stored in a cache might be the result of an earlier computation, or the duplicate of data stored elsewhere.
Clock—A device for time measurement and/or time display.
Clock Drift—A measurement of the difference in frequency between two clocks.
Clock Resolution—See Resolution
Clock Skew—A measurement of the difference in phase between two clocks.
Clock Value—An indication of time, relative to the epoch of the time source. Clock value is often communicated in seconds and fractions of a second since the epoch.
Content Addressable Memory—A special type of computer memory used in certain very-high-speed searching applications. It is also known as associative memory, associative storage, or associative array, although the last term is more often used for a programming data structure. It compares input search data (tag) against a table of stored data, and returns the address of matching data (or in the case of associative memory, the matching data).
Cryptographic Hash Algorithm—See Cryptographic Hash Function.
Cryptographic Hash Function—a hash function which takes an input, transforms it and returns a fixed-size output. An ideal hash function has three main properties:
   1) It is extremely easy to calculate a hash output for any given inputs.
   2) It is extremely computationally difficult to calculate the inputs to the cryptographic hash function that has a given output.
   3) It is extremely unlikely that two slightly different inputs will have the same hash.
Cryptographic Hash of a synchronized clock value or time—The output of a cryptographic hash function where the input to the cryptographic hash function is a synchronized clock value or time value.
Cryptographic Key—A key used to encrypt and decrypt a message.
Cryptographic Performance Attack—A cyber attack where a rogue node submits messages that trigger the execution of computationally expensive cryptographic algorithms.
Denial of Service (DoS) Attack—A cyber attack designed to overwhelm a network, device or system by flooding it with packets or other data.
Epoch—The origin of time for a given time source. For example, for GPS, the epoch is 6 January, 1980.
Filtered Time Authenticator—An apparatus for authenticating a time value from an authenticated communication prepared by a Filtered Time MAC Generator.
Filtered Time Decryptor—An apparatus for extracting a time value from a secured communication prepared by a Filtered Time Encryptor.
Filtered Time Encryptor—An apparatus for preparing a time value for secure communication.
Filtered Time MAC Generator—An apparatus for preparing a time value for authenticated communication.
Frequency Drift—The difference of the frequency from a reference.
Full Resolution Clock—A clock reporting at the smallest resolution that can be measured and/or displayed by a given instrument.
GPS—Global Positioning System. A geolocation system that is dependant upon time and can be used to communicate time.
Hash Output—The output from a hash or cryptographic hash function.
Hash Table—A hash table is a associative data structure that provides an association between hashed values and the data associated with the hashed values, thus providing an association between the values used as the input to the hash function and the data associated with the hashed values. Hash tables are used to provide an efficient method of locating data associated with complex inputs.
Imposter Clock—A clock that intentionally provides a false timing signal by masquerading as an authentic clock. By providing a false timing signal, an imposter clock can corrupt the integrity of a system.
Interactive Time Protocol—A communications protocol designed to communicate timing information that requires a response from the receiving party.
Lookup—The process of comparing input search data against a table of stored data, and returning the address of matching data or the matching data itself.
Lower Resolution Clock—A clock reported at a resolution that is less than the maximum that can be measured and/or displayed by a given instrument.
Message—A discrete unit of communication intended by the source for consumption by some recipient or group of recipients.
Message Authentication Code—a message authentication code (MAC) is a short piece of information used to authenticate a message—in other words, to confirm that the message came from the stated sender (its authenticity) and has not been changed. The MAC value protects both a message's data integrity as well as its authenticity, by allowing verifiers (who also possess the secret key) to detect any changes to the message content.
Message Body—The payload of a message, usually following a message header which identifies the origin and recipients of the message.
Message Delay Manipulation—A cyber attack that operates by delaying messages as they traverse a network.
Message Key—A key used to encrypt and decrypt a message. A message key can also be used to generate a message authentication code for a specific message.
Message Replay—See Replay Attack.
Message Spoofing—A cyber attack involving the sending of a message intended to impersonate a legitimate sender.
Non-interactive—Communications or authentication protocols that requires only one party to transmit and another party to receive.
Network—A collection of nodes, that are connected so as to enable communication between the nodes. Nodes use circuit switching, message switching or packet switching to pass the signal through the correct links and nodes to reach the correct destination node. Each node in the network usually has a unique address so messages or connections can be routed to the correct recipients. The collection of addresses in the network is called the address space.
NTP—Network Time Protocol, A protocol for communicating time.
Partial output of a cryptographic hash—A subset of the bits contained in the output of a cryptographic hash. For example, the cryptographic hash algorithm HMAC-SHA-256 produces 256 bits of output. If a time token uses 64 of those bits, then the time token uses a partial output of a cryptographic hash.
Perfect Forward Secrecy—In security, the property of learning the decryption key for a message does not affect the security of any other message.
Phase Drift—The difference of the phase from a reference.
Plaintext—Un-encrypted information.
Propagation Delay—The amount of time it takes for a signal to travel between two points of measurement.
Propagation Delay Variance—The difference in propagation delay from a reference.
PTP—Precision Time Protocol, A protocol for communicating time. Standardized in IEEE 1588.
Recognizable Clock Value—A clock value contained in a token cache entry in a token cache, enabling that clock value to be recognized by the time token filter.
Replay Attack—A cyber attack involving the insertion of previously recorded messages.
Resolution—The smallest change that can be measured and/or displayed by a given instrument.
Time—“Time” may be used to specify an instant (time of day) on a selected time-scale. In a time-scale it is a measurement of time interval between two events or the duration of an event. Time is an apparently irreversible continuum of ordered events.
Time Protocol—A communications protocol designed to communicate timing information.
Time Signal—A waveform used for the purpose of communicating time information.
The essential physical attributes of a time signal is the concept of an event in time (and space) representing an instant to which a time value is associated.
Time Token—A time sensitive message header that is used to determine the message key. A time token is generated with a specific clock value. The time token is a component of a time token protected or authenticated message.
Time Token Authenticated Message—A cryptographically authenticated message that includes a time token which is used to determine the message key.
Time Token Filter—A process or module that determines if a time token is present in a time token cache.
Time Token Generator—A process or module that generates time tokens.
Time Token Protected Message—A cryptographically secured message that includes a time token which is used to determine the message key.
Time Token Validity—The determination that a time token is present and valid in a time token cache.
Time Window—A range of time used for recognizing time tokens. The time window depends upon the resolution of the clock values used for token generation and the number of tokens generated.
Unique Time dependent message key—A message key that is used to decrypt or authenticate a time token protected message or a time token authenticated message respectively. This message key is time dependent because the message key is determined by matching its associated token. The message key is unique because every message key is different.
Unsecured Communications Channel—A method of transferring data that is not resistant to eavesdropping or tampering.
Valid Time Token—A time token that has been received by a time token filter and been located in a time token cache.
Variance in propagation delay—See Propagation Delay Variance.

### SCOPE OF THE CLAIMS

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Secure Time Communication System have been disclosed above are intended to educate the reader about preferred embodiments of the invention, and are not intended to constrain the limits of the invention or the scope of Claims.

### LIST OF REFERENCE CHARACTERS

10 Secure Time Communication System
12 Source Clock
14 Pre-Shared Key
15 Original Message
16 Filtered Time Encryptor
18 Time Token Generator
20 Message Encryptor
22 Time Token protected message
24 Transmitter
26 Receiver
28 Filtered Time Decryptor
30 Time Token Filter
31 Time Token Cache
32 Message Decryptor
34 Local Clock
40 Cryptographic Hash Output
42 Time Token
42C Cached Time Token
44 Time Token Message Key
44C Cached Time Token Message Key
46 Encrypted Time
47 Encrypted Message
48 Decrypted Clock
49 Decrypted Original Message
50 Token Cache Entry
52 Clock Value
52C Cached Clock Value
60 Unsecured Communications Channel
62 Attacker
70 FIG. 6, Step 1
72 FIG. 6, Step 2
74 FIG. 6, Step 3
76 FIG. 6, Step 4
80 FIG. 7, Step 1
82 FIG. 7, Step 2
84 FIG. 7, Step 3
90 FIG. 8, Step 1
92 FIG. 8, Step 2
94 FIG. 8, Step 3
96 FIG. 8, Step 4
98 FIG. 8, Step 5
100 FIG. 9, Step 1
102 FIG. 9, Step 2
104 FIG. 9, Step 3
106 FIG. 9, Step 4
108 FIG. 9, Step 5
120 Time Token Authenticated Message
121 First Embodiment A
122 Message Authentication Code
122L Local Message Authentication Code
124 Alternate Embodiment B
125 Retrofit Authenticated Message Format
126 Authenticated Original Message
128 Authenticated Time
130 FIG. 11, Step 1
132 FIG. 11, Step 2
134 FIG. 11, Step 3
136 FIG. 11, Step 4
150 FIG. 12, Step 1
152 FIG. 12, Step 2
154 FIG. 12, Step 3
156 FIG. 12, Step 4
158 FIG. 12, Step 5
170 FIG. 13, Step 1
172 FIG. 13, Step 2
174 FIG. 13, Step 3
176 FIG. 13, Step 4
178 FIG. 13, Step 5
188 Authenticated Time Communication System
190 Filtered Time MAC Generator
192 Message Authentication Code Generator
194 Filtered Time Authenticator
196 Message Authentication Code Authenticator

What is claimed is:

1. An apparatus comprising:
a source clock (12);
a pre-shared key (14);
an original message (15);
a filtered time encryptor (16); said filtered time encryptor (16) being connected to said source clock (12); said filtered time encryptor (16) for receiving an input from said source clock (12), and for receiving as inputs said pre-shared key (14) and said original message (15);
a transmitter (24); said transmitter (24) being connected to said filtered time encryptor (16);
a receiver (26); said receiver (26) being connected to said transmitter (24);
a filtered time decryptor (28); said filtered time decryptor (28) being connected to said receiver (26);
said filtered time encryptor (16) including
a means for a time token generator (18); and
a means for a message encryptor (20);
said filtered time decryptor (28) for receiving a time value from a local clock (34) and said pre-shared key (14);
said filtered time decryptor (28) for receiving a time token protected message (22) and including
a means for a time token filter (30); and
a means for a message decryptor (32) for said time token protected message (22);
said means for a time token filter (30) including a time token cache (31); said time token cache (31) including a plurality of token cache entries (50);
said pre-shared key (14) being provided to both said filtered time encryptor (16) and said filtered time decryptor (28);
said means for a time token generator (18) using said source clock (12) and said pre-shared key (14) to generate said time token (42) and a time token message key (44);
said means for a message encryptor (20) generating an encrypted time (46) using said time token message key (44) to encrypt said source clock (12);
said filtered time encryptor (16) combining said time token (42) and said encrypted time (46) into said time token protected message (22);
said transmitter (24) transmitting said time token protected message (22);
said receiver (26) receiving said time token protected message (22);
said filtered time decryptor (28) processing said time token protected message (22) by using said means for a time token filter (30);
said means for a time token filter (30) maintaining a time token cache (31) containing a plurality of token cache entries (50); each of said plurality of token cache entries (50) including a cached time token (42C), a cached time token message key (44C) and a cached clock value (52C);
said means for a time token filter (30) using said local clock (34) and said pre-shared key (14) to generate said cached time token (42C) and said cached time token message key (44C);
said means for a time token filter (30) extracting said time token (42) from said received time token protected message (22);
said means for a time token filter (30) extracting said encrypted time (46) from said received time token protected message (22);
said means for a time token filter (30) comparing said extracted time token (42) to each of said cached time tokens (42C) in said plurality of token cache entries (50) and determining an exact match to one of said cached time tokens (42C);
said means for a message decryptor (32) using said cached time token message key (44C) from said matched token cache entry (50) to decrypt said extracted encrypted time (46);
said token cache entry (50) being invalidated for the purpose of preventing a replay attack;
said filtered time decryptor (28) producing a decrypted original message (49); and
said filtered time decryptor (28) producing a decrypted clock (48).

2. An apparatus as described in claim 1, in which:
a value of said source clock (12) is used to generate said time token (42) having a lower resolution than the value of said source clock (12) that is used to generate said encrypted time (46).

3. An apparatus as described in claim 2 where:
said lower resolution is selected for the purpose of reducing the number of time tokens (42) required to span a time window.

4. An apparatus as described in claim 1 in which:
said filtered time decryptor (28) compares said decrypted clock (48) against said clock value used to generate said time token (42) at the highest resolution common to both clock values; and
said filtered time decryptor (28) discards said decrypted clock (48) if said compared clock values do not match.

5. An apparatus as described in claim 1, in which:
said means for a message encryptor (20) for generating said encrypted time (46) using said time token message key (44) to encrypt said source clock (12) and to encrypt additional message data.

6. An apparatus as described in claim 1, in which:
using said means for a time token filter (30) for providing an efficient filter against a cryptographic performance attack.

7. An apparatus as described in claim 1, in which:
using said means for a time token filter (30) for providing an efficient filter against a denial of service attack.

8. An apparatus as described in claim 1, in which:
using said time token message key (44) for providing perfect forward secrecy.

9. An apparatus as described in claim 1, in which:
the size in bits of said time token (42) is selected for the purpose of decreasing the probability of an attacker (62) generating said time token (42) that matches one of said plurality of said cached time token (42C) in said time token cache (31).

10. An apparatus as described in claim 1, in which:
the number of time tokens (42) in said time token cache (31) is selected for the purpose of spanning a time window.

11. An apparatus as described in claim 1, in which:
said filtered time encryptor (16) includes an original message (15); and
said filtered time decryptor (28) producing a decrypted message (49) from said decrypted encrypted time (46).

12. An apparatus comprising:
a source clock (12):
a pre-shared key (14);
an original message (15);
a filtered time MAC generator (190); said filtered time MAC generator (190) being connected to said source clock (12); said filtered time MAC generator (190) for receiving an input from said source clock (12); and for receiving as inputs said pre-shared key (14) and said original message (15);
a transmitter (24); said transmitter (24) being connected to said filtered time MAC generator (190);
a receiver (26); said receiver (26) being connected to said transmitter (24);
a filtered time authenticator (194);
said filtered time MAC generator (190) including
a means for a time token generator (18);
a means for a message authentication code generator (192);
said filtered time authenticator (194) including
a means for a time token filter (30);
a means for a message authentication code authenticator (196);
said means a message authentication code authenticator (196) for receiving as an input said pre-shared key (14); and
a local clock (34); and
said means for a time token filter (30) including a time token cache (31);
said pre-shared key (14) being provided to both said filtered time MAC generator (190) and to said filtered time authenticator (194);
said means for a time token generator (18) using said source clock (12) and said pre-shared key (14) to generate a time token (42) and a time token message key (44);
said means for a message authentication code generator (192) generating a message authentication code (122) using said time token message key (44) and said source clock (12);
said filtered time MAC generator (190) combining said time token (42), said message authentication code (122) and said source clock (12) into a time token authenticated message (120);
said transmitter (24) transmitting said time token authenticated message (120);
said receiver (26) receiving said time token authenticated message (120);
said filtered time authenticator (194) processing said time token authenticated message (120) by using said means for a time token filter (30);
said means for a time token filter (30) maintaining a time token cache (31) containing a plurality of token cache entries (50); each of said plurality of token cache entries (50) including a cached time token (42C), a cached time token message key (44C) and a cached clock value (52C);
said means for a time token filter (30) using said local clock (34) and said pre-shared key (14) to generate said cached time token (42C) and said cached time token message key (44C);
said means (30) for filtering time tokens extracting said time token (42) from said received time token authenticated message (120);
said means (30) for filtering time tokens extracting said message authentication code (122) from said received time token authenticated message (120);
said means (30) for filtering time tokens extracting said source clock (12) from said received time token authenticated message (120);
said means for a time token filter (30) comparing said extracted time token (42) to each of said cached time tokens (42C) in said plurality of token cache entries (50) and determining an exact match to one of said cached time tokens (42C);
said means for a message authentication code authenticator (196) using said cached time token message key (44C) from said matched token cache entry (50) to generate a local message authentication code (122L);
said means for a message authentication code authenticator (196) comparing said extracted message authentication code (122) to said local message authentication code (122L) and determining an exact match;
said token cache entry (50) being invalidated for the purpose of preventing a replay attack; and
said filtered time authenticator (196) authenticating said source clock (12) from said authenticated time token authenticated message (120).

13. An apparatus as described in claim 12, in which:
said source clock (12) used to generate said time token (42) at said filtered time MAC generator (190) is of a different resolution from the source clock (12) extracted from said received time token authenticated message (120) at said filtered time authenticator (194).

14. An apparatus as described in claim 13 where:
said resolution is selected for the purpose of reducing the number of cached time tokens (42C) required to span a time window.

15. An apparatus as described in claim 12, in which:
said means for a message authentication code generator (192) generating said message authentication code (122) using said time token message key (44) and said original message (15).

16. An apparatus as described in claim 12, in which:
using said means for a time token filter (30) for providing an efficient filter against a cryptographic performance attack.

17. An apparatus as described in claim 12, in which:
using said means for a time token filter (30) for providing an efficient filter against a denial of service attack.

18. An apparatus as described in claim 12, in which:
the size in bits of said time token (42) is selected for the purpose of decreasing the probability of an attacker (62) generating a time token (42) that matches a time token (42) in said time token cache (31).

19. An apparatus as described in claim 12, in which:
the number of cached time tokens (42C) in said time token cache (31) is selected for the purpose of spanning a time window.

20. An apparatus as described in claim 12, in which:
said filtered time MAC generator (190) including an original message (15); and
said filtered time authenticator (194) producing an authenticated original message (126) from said time token authenticated message (120).

21. An apparatus as described in claim 12, in which:
said time token authenticated message (120) is in a retrofit authenticated message format (125) for the purpose of enabling operation in existing time communication systems.
